(19) United States
(12) Patent Application Publication
(10) Pub. No.: US 2013/0096982 A1
(43) Pub. Date: Apr. 18, 2013

(54) INTEREST LEVEL ESTIMATION APPARATUS, INTEREST LEVEL ESTIMATION METHOD, AND COMPUTER-READABLE RECORDING MEDIUM

(71) Applicants: Yoji Miyazaki, Tokyo (JP); Yuki Chiba, Tokyo (JP)

(72) Inventors: Yoji Miyazaki, Tokyo (JP); Yuki Chiba, Tokyo (JP)

(73) Assignee: NEC CORPORATION, Tokyo (JP)

(21) Appl. No.: 13/704,675

(22) PCT Filed: Jun. 13, 2011
(86) PCT No.: PCT/JP2011/063476

§ 371 Date: Dec. 17, 2012

(30) Foreign Application Priority Data
Jun. 24, 2010 (JP) 2010-143585
Aug. 24, 2010 (JP) 2010-187374

(51) Int. Cl. G06Q 30/02

(52) U.S. Cl. CPC G06Q 30/0201
USPC 705/7.29

(57) ABSTRACT

An interest level estimation apparatus 10 is provided with an interest level estimation unit 11 that, using at least one of environmental information specifying an environment of every section within a specific space 100 and position information specifying a position of every section, and visitor number information specifying, for every section, the number of people visiting the section, estimates, for every section, a level of interest indicating a level to which people visiting the section are interested in the section.

### TECHNICAL FIELD

The present invention relates to an interest level estimation apparatus, an interest level estimation method and a computer-readable recording medium that are for estimating a customer's level of interest in each sales counter of a store.

### BACKGROUND ART

Large-scale stores such as supermarkets, department stores and fashion buildings, for example, have been using human motion sensors and the like in recent years to detect people visiting the store. The detection results are then used for analyzing the customer drawing power of each counter of a store, as well as for digital signage and the like (e.g., see Patent Documents 1 and 2).

For example, Patent Document 1 discloses an analysis apparatus that uses a human motion sensor or the like to detect the number of people who frequented the store and the number of the people who passed by products, and performs product sales analysis based on the detection results, the layout of products in the store, and sales information from when products are sold. According to the analysis apparatus disclosed in Patent Document 1, because sales analysis results for specific products can be compared between stores, the reason for poor sales in a store in which a specific product is not selling can be specified.

Also, Patent Document 2 discloses a display device that functions as digital signage. The display device disclosed in Patent Document 2 is provided with a human motion sensor that detects people in the vicinity thereof, and is able to utilize detection results as digital signage. Specifically, according to the display device disclosed in Patent Document 2, the number of people taking an interest can be specified for every advertising content that is displayed, and advertising with a high sales promotion effect can be analyzed. Also, according to the display device disclosed in Patent Document 2, the level of sound output together with advertising video images, the brightness of the screen and the like can also be changed, according to the number of people taking an interest.

### CITATION LIST

### Patent Document

Patent Document 1: JP 2007-179199A

Patent Document 2: JP 2010-78867A

### DISCLOSURE OF THE INVENTION

### Problem to be Solved by the Invention

In this way, with the technology disclosed in Patent Documents 1 and 2, the number of people who visited the store is detected, and various types of analysis are then performed based on the detected values. However, correctly estimating the actual situation is difficult with only information indicating that the number of people was large or small.

For example, in the case where there are lots of people around the entrance but nobody at a distance from the entrance, the analysis apparatus disclosed in Patent Document 1 could possibly simply conclude that the products disposed near an entrance are popular items. Also, in the case where an unpopular product is laid out along the line of flow toward a location where a popular product is laid out, lots of people will pass by that area despite the product not being a popular item. In this case, the analysis apparatus disclosed in Patent Document 1 may possibly conclude that this unpopular product is a popular product.

Similarly, with the display device disclosed in Patent Document 2 that functions as digital signage, since the number of detected people is conceivably affected by products laid out next to the display device, it is difficult to correctly analyze advertising with this display device.

There is thus a problem with the technology disclosed in Patent Documents 1 and 2 in that reliability of the analysis results is low. Accordingly, with various types of analysis carried out in a specific space such as a store, there are calls for a new index to be proposed that is able to directly represent the actual situation in a specific space.

An exemplary object of the present invention is to solve the above problems and provide an interest level estimation apparatus, an interest level estimation method, and a computer-readable recording medium that can provide an index capable of representing the actual situation in a specific space.

### Means for Solving the Problem

In order to attain the above object, an interest level estimation apparatus according to one aspect of the present invention includes an interest level estimation unit that, using at least one of environmental information specifying an environment of every section within a specific space and position information specifying a position of every section, and visitor number information specifying, for every section, the number of people visiting the section, estimates, for every section, a level of interest indicating a level to which people visiting the section are interested in the section.

Also, in order to attain the above object, an interest level estimation method according to one aspect of the present invention includes an interest level estimation step of using at least one of environmental information specifying an environment of every section within a specific space and position information specifying a position of every section, and visitor number information specifying, for every section, the number of people visiting the section, to estimate, for every section, a level of interest indicating a level to which people visiting the section are interested in the section.

Furthermore, in order to attain the above object, a computer-readable recording medium according to one aspect of the present invention has recorded thereon a program including a command for causing a computer to execute an interest level estimation step of using at least one of environmental information specifying an environment of every section within a specific space and position information specifying a position of every section, and visitor number information specifying, for every section, the number of people visiting the section, to estimate, for every section, a level of interest indicating a level to which people visiting the section are interested in the section.

### Effects of the Invention

As mentioned above, according to an interest level estimation apparatus in the present invention, an interest level estimation method and a computer-readable recording medium of the present invention, an index capable of representing the actual situation in a specific space can be presented.

### BRIEF DESCRIPTION OF DRAWINGS

FIG. 1 is a block diagram showing a configuration of an interest level estimation apparatus in Embodiment 1 of the present invention.

FIG. 2 is a diagram showing the interest level estimation apparatus shown in FIG. 1 and specific spaces targeted for interest level estimation.

FIG. 3 is a diagram showing an enlarged view of one specific space targeted for interest level estimation in Embodiment 1 of the present invention.

FIG. 4 is a flowchart showing operations of the interest level estimation apparatus in Embodiment 1 of the present invention.

FIG. 5 is a diagram showing exemplary visitor number information and environmental information acquired in Embodiment 1 of the present invention.

FIG. 6 is a diagram showing exemplary counter attribute information utilized in Embodiment 1 of the present invention.

FIG. 7 is a diagram showing a first exemplary interest level display mode in Embodiment 1 of the present invention.

FIG. 8 is a diagram showing a second exemplary interest level display mode in Embodiment 1 of the present invention.

FIG. 9 is a diagram showing the third exemplary interest level display mode in Embodiment 1 of the present invention.

FIG. 10 is a diagram showing a fourth exemplary interest level display mode in Embodiment 1 of the present invention.

FIG. 11 is a diagram showing exemplary output of a human motion sensor installed in a counter.

FIG. 12 is a diagram showing the relationship between actual visitor numbers obtained by investigation and visitor numbers computed using a regression equation.

FIG. 13 is a diagram showing the residual error between actual visitor numbers obtained through investigation and computed visitor numbers.

FIG. 14A, FIG. 14B, and FIG. 14C respectively show exemplary visitor numbers computed using a regression equation.

FIG. 15 is a block diagram showing a configuration of an interest level estimation apparatus in Embodiment 2 of the present invention.

FIG. 16 is a flowchart showing operations of the interest level estimation apparatus in Embodiment 2 of the present invention.

FIG. 17 is a block diagram showing a configuration of an interest level estimation apparatus in Embodiment 3 of the present invention.

FIG. 18 shows an exemplary space targeted for interest level estimation in Embodiment 3 of the present invention.

FIG. 19 is a flowchart showing operations of the interest level estimation apparatus in Embodiment 3 of the present invention.

FIG. 20 is a flowchart specifically showing prediction processing shown in FIG. 19.

FIG. 21 is a diagram specifically illustrating steps C63 to C64 shown in FIG. 20.

FIG. 22 is a block diagram showing a configuration of an interest level estimation apparatus in Embodiment 4 of the present invention.

FIG. 23 shows an exemplary space targeted for interest level estimation in Embodiment 4 of the present invention.

FIG. 24 is a flowchart showing operations of the interest level estimation apparatus in Embodiment 4 of the present invention.

FIG. 25 is a diagram showing examples of respective counter attribute information for floor A and floor B shown in FIG. 23.

FIG. 26 is a diagram showing examples of respective changes in interest level for floor A and floor B shown in FIG. 23.

FIG. 27 is a diagram showing an exemplary interest level display mode in Embodiment 4 of the present invention.

FIG. 28 is a block diagram showing an exemplary computer that realizes the interest level estimation apparatuses in Embodiments 1 to 4 of the present invention.

### DESCRIPTION OF EMBODIMENTS

### Embodiment 1

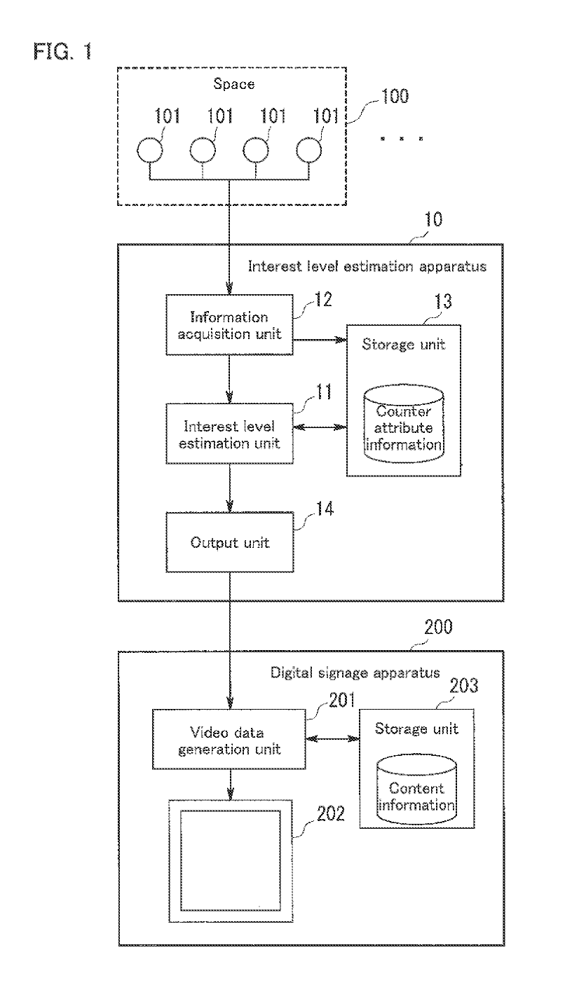

Hereinafter, an interest level estimation apparatus, an interest level estimation method and a program in Embodiment 1 of the present invention will be described, with reference to FIGS. 1 to 10.

Apparatus Configuration

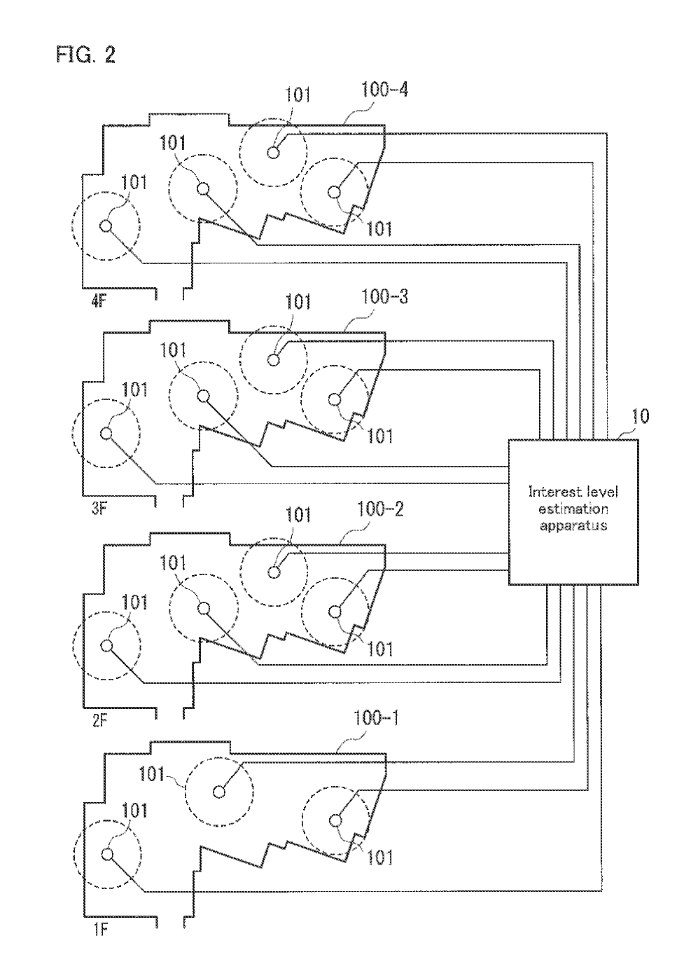

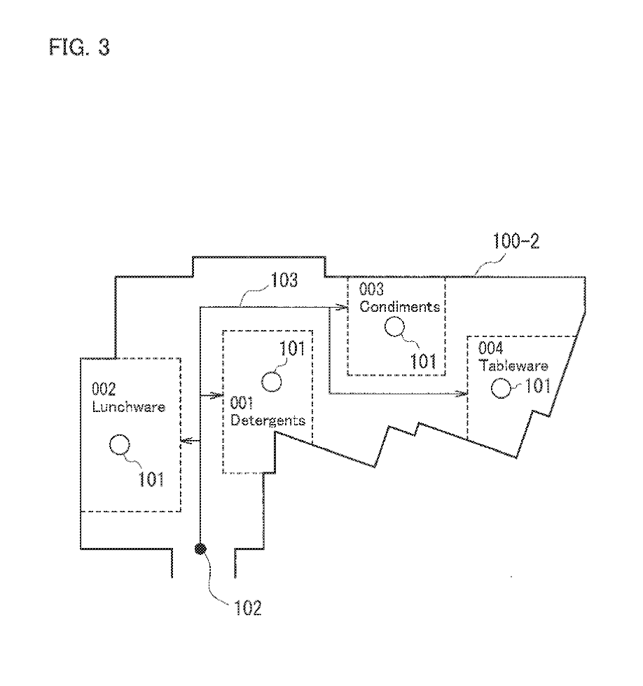

Initially, a configuration of an interest level estimation apparatus 10 in the present Embodiment 1 will be described, using FIGS. 1 to 3. FIG. 1 is a block diagram showing a configuration of the interest level estimation apparatus in Embodiment 1 of the present invention. FIG. 2 is a diagram showing the interest level estimation apparatus shown in FIG. 1 and specific spaces targeted for interest level estimation. FIG. 3 is a diagram showing an enlarged view of one of the specific spaces targeted for interest level estimation in Embodiment 1 of the present invention.

As shown in FIG. 1, the interest level estimation apparatus 10 is provided with an interest level estimation unit 11. The interest level estimation unit 11 estimates the level of interest for every section in a specific space 100, using at least one of environmental information specifying the environment of every section and position information specifying the position of every section, and visitor number information specifying for every section the number of people visiting that section. The level of interest is an index indicating the level to which people visiting a target section are interested in that section.

In this way, the interest level estimation apparatus 10 estimates the level of interest, utilizing not only the number of people visiting a target section but also the environmental information of the target section or the position information of the target section, or all of these. The level of interest thus serves as an index representing the actual situation in a specific space. Therefore, by utilizing the level of interest estimated by the interest level estimation apparatus 10, improvement in the accuracy of various types of analysis such as sales analysis and advertising analysis is achieved.

Here, the configuration of the interest level estimation apparatus 10 will be described more specifically, with reference to FIG. 2 in addition to FIG. 1. As shown in FIG. 2, in the present Embodiment 1, the specific spaces targeted for interest level estimation are the four spaces 100-1 to 100-4. Also, as shown in FIGS. 1 and 2, the interest level estimation apparatus 10 is connected to sensor posts 101 that output environmental information and visitor number information.

A “sensor post” is a sensor terminal that generally is disposed in a space, such as a store or an office, and detects various types of information such as environmental information and visitor number information. Also, a “sensor post” is equipped with various sensors, according to the information that will be detected.

In the present Embodiment 1, a sensor post 101 is installed for every section of the respective spaces 100-1 to 100-4. The interest level estimation apparatus 10 estimates the level of interest for every section, with respect to each of the spaces 101-1 to 101-4, using the environmental information and the visitor number information output by each sensor post 101.

Also, in the present Embodiment 1, the spaces 100-1 to 100-4 are spaces constituted by the floors of a commercial building. Examples of the sections of each space 100-1 to 100-4 include counters provided on each floor. In this case, as shown in FIG. 3, a sensor post 101 is installed for every counter, and the interest level estimation apparatus 10 estimates the level of interest for every counter on each floor.

A specific example of the space 100-2 is shown in FIG. 3. Also, in the present Embodiment 1, a single section corresponds to a single counter in the respective spaces 100-1 to 100-4. Therefore, in the present Embodiment 1, the “sections” will be referred to as “counters” in subsequent description.

The present Embodiment 1 is not, however, limited to the above example, and one section may be constituted by two or more counters in the respective spaces 100-1 to 100-4, for example. Also, although one sensor post is disposed for one counter in the example in FIG. 3, in the present Embodiment 1 one sensor post may be disposed for every two or more counters.

In the present Embodiment 1, the specific space targeted for interest level estimation is not limited to the space constituting an entire floor. The specific space may, for example, be part of the space of one floor, or a plurality of specific spaces may exist on one floor. Also, the entire interior space of a building such as a gymnasium or a music hall may be taken as a specific space. Furthermore, although a plurality of specific spaces are targeted by the interest level estimation apparatus 10 in the example in FIG. 1, the present embodiment is not limited thereto, and one specific space may be targeted.

Also, in the present Embodiment 1, the sensor posts 101 are provided with a human motion sensor and an environmental sensor. Specifically, a human motion sensor is a sensor that detects people who are present in a target area, using infrared rays, ultrasonic waves, visible light or a combination thereof. An environmental sensor is a sensor that detects the environment of a target area, with examples of environmental sensors including a sound sensor that detects the sound pressure of a target area and a temperature sensor that detects the temperature of a target area.

Note that, in subsequent description, it is assumed that a sound sensor and a temperature sensor are used as environmental sensors.

Also, the sensor posts 101 are each installed so that the counter to which the sensor post corresponds is included in the target area. In FIG. 2, the dashed lines around the sensor posts 101 indicate the target areas of the sensor posts 101.

As shown in FIG. 1, in the present Embodiment 1, the interest level estimation apparatus 10 is provided with an information acquisition unit 12, a storage unit 13, and an output unit 14, in addition to the interest level estimation unit 11. Also, a digital signage apparatus 200 is connected to the interest level estimation apparatus 10.

The information acquisition unit 12 acquires environmental information of every counter from the environmental sensors constituting the sensor posts 101, and further acquires visitor number information of every counter from the human motion sensors constituting the sensor posts 101. The information acquisition unit 12 then outputs the acquired environmental information and visitor number information to the interest level estimation unit 11.

Also, as mentioned above, in the present Embodiment 1, a sound sensor and a temperature sensor are used as environmental sensors. Therefore, the information acquisition unit 12 acquires information specifying the sound pressure of counters and information specifying the temperature of counters as environmental information. Note that, given that the sound volume for counters is derived from the sound pressure at counters, as will be discussed later, information specifying the sound pressure at counters can be regarded as “information specifying the volume for counters”.

The storage unit 13 stores position information. In the present Embodiment 1, position information may be any information capable of specifying the position of each counter in a specific space. For example, the position information may be the distance from the entrance of the specific space to each counter, or may be the coordinates of the counters in a coordinate system set in the specific space. A specific example of the former is the distance on a line of flow 103 (see FIG. 3) from a reference point 102 of the space entrance to each counter (hereinafter, “line-of-flow distance”). Also, a two-dimensional coordinate system whose origin is the reference point 102 of the space entrance may be set, with a specific example of the latter being the coordinates of each counter in this two-dimensional coordinate system.

In the present Embodiment 1, the abovementioned information acquisition unit 12 is also able to output the acquired environmental information and visitor number information to the storage unit 13. In this case, the storage unit 13 is able to store the output environmental information and visitor number information as past information, in addition to the position information. The storage unit 13 is also able to store numerical values (average visitor number, average volume, average temperature, etc.; hereinafter, referred to as “computed values”) that are computed from past environmental information or past visitor number information. Furthermore, in such a case, the storage unit 13 stores position information, past environmental information, past visitor number information and computed values for every counter of each space. Note that the position information, past environmental information, past visitor number information and computed values is information representing attributes of each counter, and will be collectively referred to as “counter attribute information”.

In the present Embodiment 1, the interest level estimation unit 11 then estimates the level of interest for every counter of each space, using counter attribute information stored in the storage unit, environmental information acquired by the information acquisition unit 12, and visitor number information likewise acquired by the information acquisition unit 12. Note that the specific processing by the interest level estimation unit 11 will be discussed in the following description of operations.

The output unit 14 receives the levels of interest estimated by the interest level estimation unit 11, and outputs interest level information specifying the levels of interest to the digital signage apparatus 200. The digital signage apparatus 200 is provided with a video data generation unit 201, a display device 202, and a storage unit 203. The video data generation unit 201 reads out the data of various contents (moving images, still images, audio, music, etc.) stored in the storage unit 203, and generates video data. Also, the video data generation unit 201 also generates video data for displaying the level of interest on a screen of the display device 202, based on the interest level information output by the interest level estimation apparatus 10. Also, the display device 202 is a liquid crystal display device or the like.

Operations

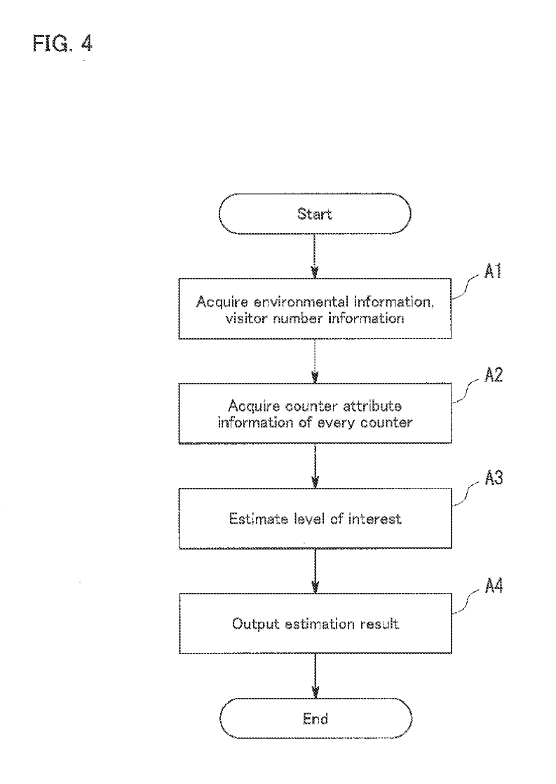

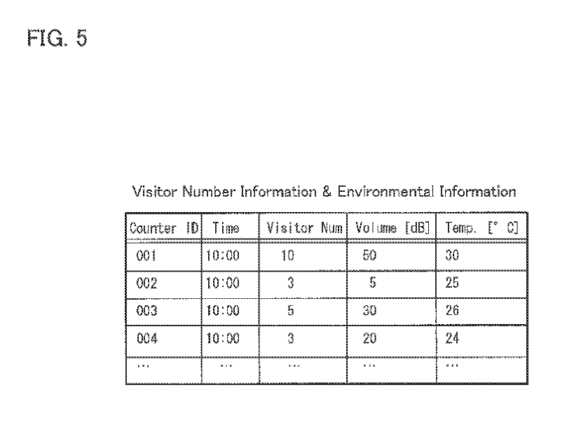

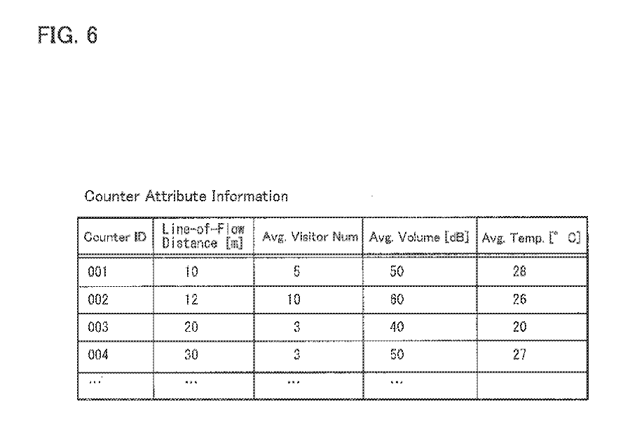

Next, operations of the interest level estimation apparatus 10 in Embodiment 1 of the present invention will be described using FIGS. 4 to 6. FIG. 4 is a flowchart showing operations of the interest level estimation apparatus in Embodiment 1 of the present invention. FIG. 5 is a diagram showing exemplary visitor number information and environmental information acquired in Embodiment 1 of the present invention. FIG. 6 is a diagram showing exemplary counter attribute information utilized in Embodiment 1 of the present invention.

In the following description, FIGS. 1 to 3 are taken into consideration as appropriate. Also, in the present Embodiment 1, the interest level estimation method is implemented by operating the interest level estimation apparatus 10. Therefore, description of the interest level estimation method in the present Embodiment 1 is replaced with the following description of operations of the interest level estimation apparatus 10. Also, in the following description, it is assumed that a sound sensor and a temperature sensor are provided in each sensor post 101, and that environmental information includes information specifying the sound pressure (volume) of the counters and information specifying the temperature of the counters.

As shown in FIG. 4, initially, the information acquisition unit 12 acquires environmental information and visitor number information from each sensor post 101 (step A1). The information shown in FIG. 5 is given as environmental information and visitor number information acquired at step A1. The various types of information output from a sensor post 101 are, however, actually the respective output signals of the human motion sensor, the sound sensor, and the temperature sensor. The information acquisition unit 12 thus performs arithmetic processing on each output signal, and computes the visitor numbers, volumes and temperatures shown in FIG. 5.

Here, the human motion sensor is a sensor for measuring the location of people. The human motion sensor detects the presence of people in a measurement target area and their movement, using infrared rays, ultrasonic waves, visible light or the like. The human motion sensor then outputs a binary signal that is ON (1) when people are present (i.e., when there is movement) and OFF (0) when people are not present (i.e., when there is no movement).

The information acquisition unit 12 computes the visitor numbers per unit time, by aggregating the binary signals output by the human motion sensors and the output times (response times) every fixed period, and applying a regression equation derived in advance to the aggregation results. The regression equation is derived by performing regression analysis using a rule prepared in advance, a calculation formula prepared in advance, the number of people at each counter collected beforehand by means other than a sensor, sensor data and the like. A more specific description of the method of calculating the regression equation and an example of computing visitor numbers using the regression equation will be given later.

Also, the sound sensors output signals indicating the sound pressure levels of the corresponding counters. The information acquisition unit 12 derives natural logarithms of the ratios of the obtained sound pressure levels and preset reference sound pressure levels, and computes the volumes of the corresponding counters from the derived logarithmic values. Furthermore, the temperature sensors output signals indicating the temperature levels of the corresponding counters. Therefore, the information acquisition unit 12 computes the temperatures of the corresponding counters from the obtained temperature levels.

At step A1, the information acquisition unit 12 outputs the computed visitor numbers, volumes and temperatures to the interest level estimation unit 11. The information acquisition unit 12 is also able to output the visitor numbers, volumes and temperatures that were obtained at step A1 to the storage unit 13, and in this case the visitor numbers, volumes and temperatures obtained at step A1 are stored in the storage unit 13 as past information.

Next, the interest level estimation unit 11 accesses the storage unit 13 and acquires the counter attribute information of every counter (step A2). The information shown in FIG. 6 is given as counter attribute information acquired at step A2. In the example in FIG. 6, the line-of-flow distance of each counter is used as the position information of each counter.

Also, the counter attribute information shown in FIG. 6 includes the average value of the visitor numbers for every counter (hereinafter, “average visitor number”), the average value of the volumes for every counter (hereinafter, “average volume”), and the average value of the temperatures for every counter (hereinafter, “average temperature”), in addition to the position information (line-of-flow distance). Note that in the present Embodiment 1, the average visitor number, the average volume and the average temperature are computed in advance by the operator of the interest level estimation apparatus 10 from values previously acquired by the information acquisition unit 12, and stored in the storage unit 13.

Next, the interest level estimation unit 11 estimates the level of interest for every counter, using the environmental information and visitor number information (specifically, visitor number, volume and temperature) acquired at step A1, and the counter attribute information of every counter acquired at step A2 (step A3). Also, the interest level estimation unit 11 outputs the estimation results to the output unit 14. Specifically, at step A3, the interest level estimation unit 11 computes the level of interest, using a preset computation formula. Also, the computation formula is not particularly limited. Specific examples of the computation formula are shown below.

One specific example of the computation formula is shown as the following formula 1. In following formula 1, α, β, and γ are weight coefficients. In the case where the following formula 1 is used, the interest level estimation unit 11 computes the level of interest for every counter, from a value obtained by multiplying the visitor number of the counter by the weight coefficient α, a value obtained by multiplying a ratio of the line-of-flow distance of the counter relative to the total value of the line-of-flow distances of all the counters in the target space by the weight coefficient β, and a value obtained by multiplying the volume for the counter by the weight coefficient γ. Note that in the case where the interest level estimation unit 11 uses the following formula 1, the counter attribute information may be only position information.

$$Level of Interest = α ( visitor num ) + β \frac{line of flow dist .}{{\sum }_{all counters} line of flow dist . } + γ ( vol . ) \qquad Formula 1$$

Also, in the above formula 1, the weight coefficients α, β and γ are set as appropriate within a defined range (e.g., range of 0 to 1), according to the actual situation, that is, according to the element to be given importance. For example, in the case where importance is given to the line-of-flow distance from the entrance to the counters, the value of the weight coefficient β is set higher than the values of the other weight coefficients. Also, in the case where a bargain sale or the like is being held, and the counter to which people are being intentionally attracted is targeted, the value of the weight coefficient α is set lower than the values of the other weight coefficients. Furthermore, in the case where a counter at which sound is constantly being output due to a video being shown, digital signage or the like is targeted, the value of the weight coefficient γ is set lower than the values of the other weight coefficients.

Another computation formula is shown as the following formula 2. In following formula 2, α, β, and γ are weight coefficients, similarly to formula 1. In the case where the following formula 2 is used, the interest level estimation unit 11 computes the level of interest for every counter, from a value obtained by multiplying the difference between the visitor number of the counter and the average visitor number by the weight coefficient α, a value obtained by multiplying a ratio of the line-of-flow distance of the counter relative to the total value of the line-of-flow distances of all the counters in the target space by the weight coefficient β, a value obtained by multiplying the difference between the volume for the counter and the average volume by the weight coefficient γ, and a value obtained by multiplying the difference between the temperature for the counter and the average temperature by a weight coefficient η. When the following formula 2 is used, the level of interest increases as the difference between the current situation of each counter and the usual situation increases.

$$Level of Interest = α ( visitor num - avg . visitor num ) + β \frac{line of flow dist .}{{\sum }_{all counters} line of flow dist . } + γ ( vol . - avg . vol . ) + η \vert temp . - avg . temp . \vert \qquad Formula 2$$

In the above formula 2, the weight coefficients α, β and γ are set similarly to the case of the above formula 1. Also, the weight coefficient η is also set as appropriate within a defined range (e.g., range of 0 to 1), according to the actual situation, that is, according to the element to be given importance. For example, in the case where a counter at which a low temperature is set such as a foodstuffs counter is targeted, the value of the weight coefficient η is set lower than the values of the other weight coefficients.

Another computation formula is also shown as the following formula 3. Also in following formula 3, α, β and γ are weight coefficients, similarly to formula 1. In the case where the following formula 3 is used, however, a lowest visitor number, a reference volume and a reference temperature are stored in the storage unit 13 as counter attribute information, instead of the average visitor number, average volume and average temperature shown in FIG. 6. Of these, the lowest visitor number is the smallest number of visitors of every counter previously acquired by the information acquisition unit 12. The reference volume is a reference value set in advance for volume. The reference temperature is a reference value set in advance for temperature.

In the case where the following formula 3 is used, the interest level estimation unit 11 computes the level of interest for every counter, from a value obtained by multiplying a ratio of the visitor number of the counter relative to the lowest visitor number by the weight coefficient α, a value obtained by multiplying a ratio of the line-of-flow distance of the counter relative to the total value of the line-of-flow distances of all the counters in the target space by the weight coefficient β, a value obtained by multiplying a ratio of the volume for the counter relative to the reference volume by the weight coefficient γ, and a value obtained by multiplying a ratio of the temperature for the counter relative to the reference temperature by the weight coefficient η. When the following formula 3 is used, the level of interest increases as the difference between the current situation of each counter and the situation serving as a reference increases.

$$Level of Interest = α ( \frac{visitor num}{lowest visitor num} ) + β \frac{line of flow dist .}{{\sum }_{all counters} line of flow dist . } + γ ( \frac{vol .}{ref . vol .} ) + η \vert temp . - ref . temp . \vert \qquad Formula 3$$

Also, in the above formula 3, the weight coefficient α, β, and γ and η are set as appropriate within a defined range (e.g., range of 0 to 1), according to the actual situation, that is, according to the element to be given importance, similarly to the above formulas 1 and 2. Furthermore, in the above formula 3, the reference volume and the reference temperature are also set as appropriate according to the actual situation. For example, in the case where a counter at which sound is constantly being output due to a video being shown, digital signage or the like is targeted, the reference volume is set to a greater value than for counters at which this is not the case. Furthermore, in the case where a counter at which a low temperature is set such as a foodstuffs counter is targeted, the reference temperature is set to a lower value than for counters at which this is not the case.

Thereafter, the output unit 14 receives the levels of interest estimated by the interest level estimation unit 11, and outputs interest level information specifying the levels of interest to the digital signage apparatus 200 (step A4). The interest level estimation processing for one space ends as a result of the execution of step A4. Also, in the case where there is another space that requires interest level estimation, steps A1 to A4 are executed again, targeting this other space.

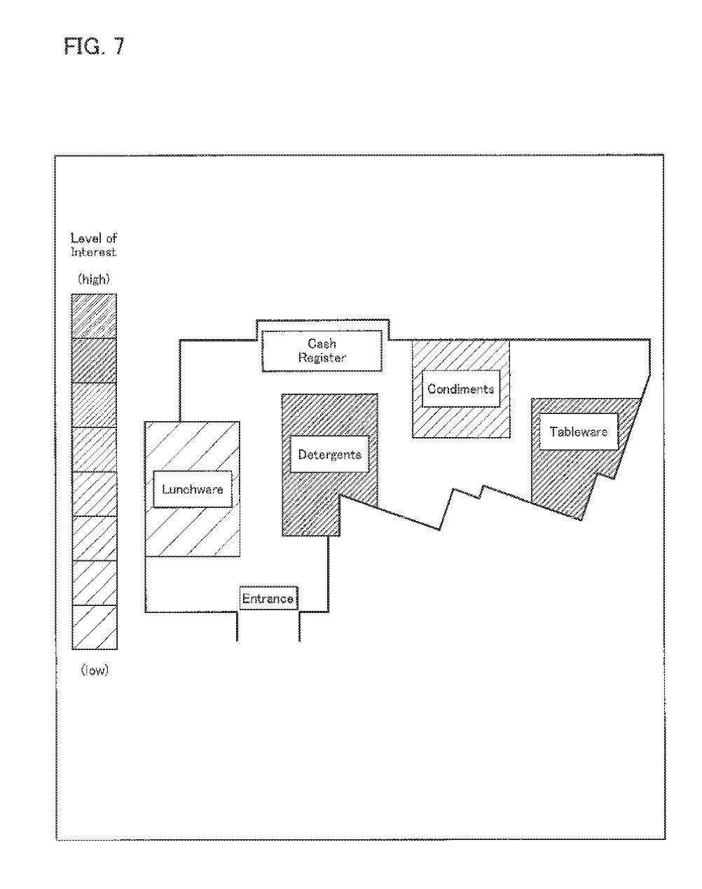

Also, after the execution of step A4, the digital signage apparatus 200 displays the levels of interest on the screen of the display device 202, based on the interest level information output from the output unit 14 of the interest level estimation apparatus 10. Here, the mode of a display of the level of interest will be described using FIGS. 7 to 10. FIGS. 7 to 10 are diagrams respectively showing first to fourth examples of the interest level display mode in Embodiment 1 of the present invention. Also, hereinafter, the case where the level of interest of each counter in the space 100-2 shown in FIG. 3 is estimated will be described.

As shown in FIG. 7, in the first example, the space targeted for interest level estimation and the counters constituting that space are displayed on the screen of the display device 202. The level of interest for every counter is then represented by color, pattern or the like. In the case where the first example is employed, the user is able to visually grasp which counters have a high level of interest.

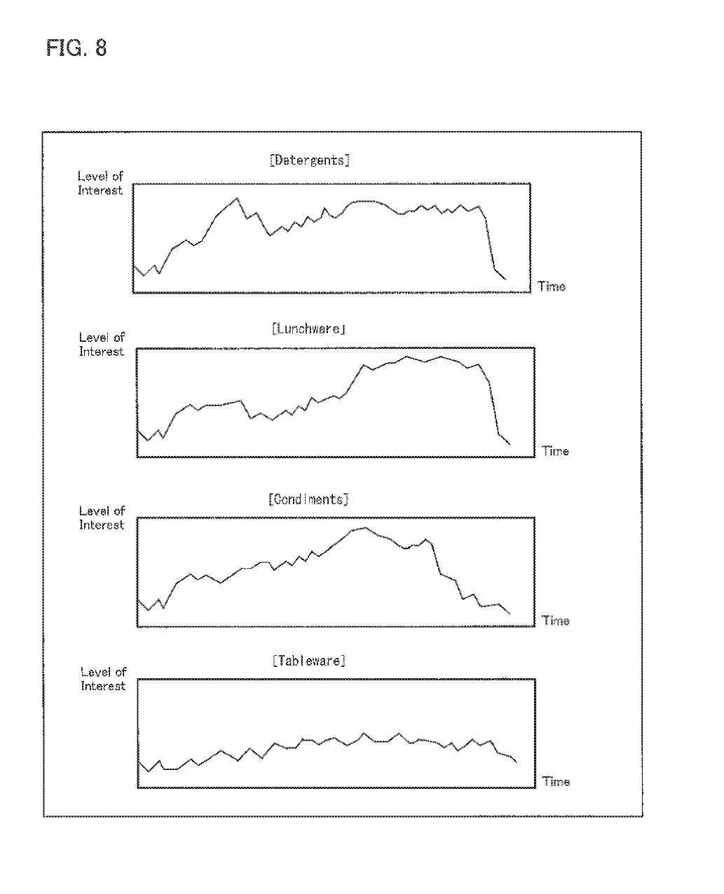

As shown in FIG. 8, in the second example, the change in interest level over time is displayed on the screen of the display device 202 for every counter using graphs. In the case where the second example is employed, the user is able to visually grasp which counters have a high level of interest in what time slots.

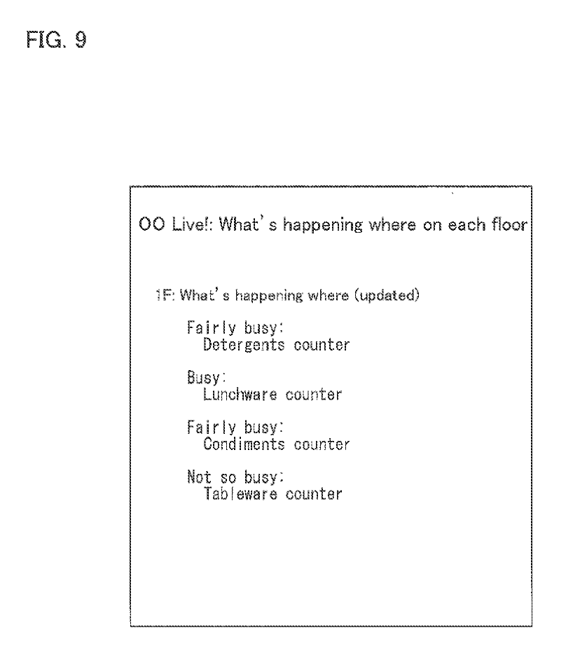

As shown in FIG. 9, in the third example, a level of interest represented with text is displayed on the screen of the display device 202 for every counter. In the case where the third example is employed, the user is able to grasp which counters have a high level of interest from the textual representation.

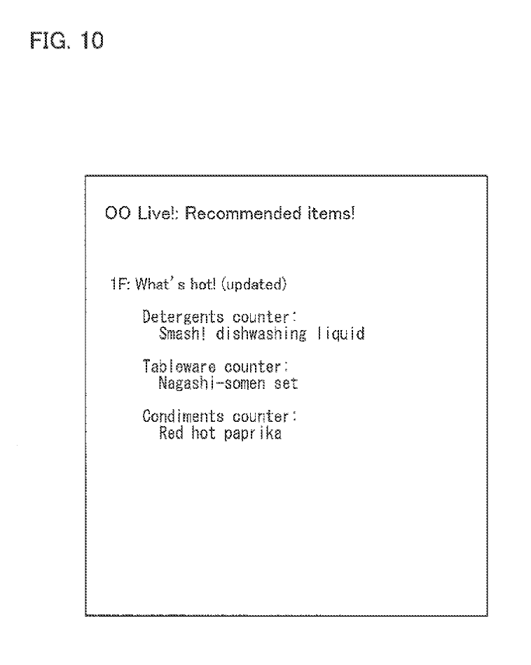

As shown in FIG. 10, in the fourth example, a recommended product is displayed on the screen of the display device 202 for every counter, according to the strength of the level of interest. That is, in the fourth example, recommended products for when the level of interest is high, recommended products for when the level of interest is moderate, and recommended products for when the level of interest is low are set in advance for every counter in the digital signage apparatus 200. The digital signage apparatus 200 then displays the recommended products corresponding to the levels of interest at that time on the screen of the display device 202. In the case where the fourth example is employed, the user is able to easily grasp the recommended products for every counter.

With the present Embodiment 1 as described above, the level of interest is computed also using elements representing the actual situation such as volume, temperature and position, in addition to the visitor number of each counter in the specific space. The level of interest thus serves as an index representing the actual situation.

The program in the present Embodiment 1 may be any program that causes a computer to execute steps A1 to A4 shown in FIG. 4. The interest level estimation apparatus 10 and the interest level estimation method in the present Embodiment 1 can be realized by installing and executing this program on a computer.

In this case, the CPU (Central Processing Unit) of the computer functions as the information acquisition unit 12 and the interest level estimation unit 11, and performs processing. Also, an external connection interface of the computer functions as the output unit 14, and a hard disk or the like provided in the computer functions as the storage unit 13.

Also, although visitor number information, environmental information and position information are all used for interest level estimation in the abovementioned example, the present Embodiment 1 is not limited to this mode. In the present Embodiment 1, the level of interest may be estimated, using only visitor number information and position information or using only visitor number information and environmental information, for example.

Furthermore, although visitor number information is acquired from human motion sensors (sensor posts 101) installed in each space in the abovementioned example, the present Embodiment 1 is also not limited to this mode. Visitor number information may be acquired from the video images of a camera installed in each zone, radio waves emitted by mobile terminals carried by the people who are visiting, RFID (Radio Frequency Identification) attached to the people who are visiting, or a combination thereof.

Also, in the present Embodiment 1, counter attribute information may include information other than the abovementioned position information, past environmental information, past visitor number information and computed values, such as the type of products displayed at the counters, the genre of those products, or the like, for example.

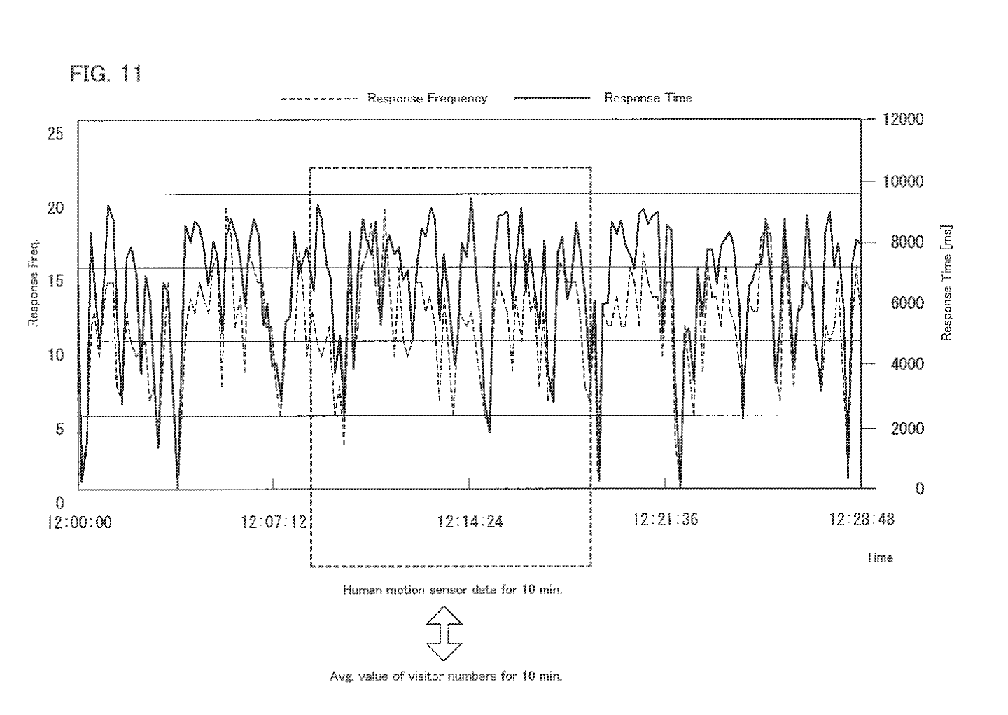

Here, computation of visitor numbers in the information acquisition unit 12 using human motion sensors will be described. Specifically, a method of calculating the regression equation and a method of calculating visitor numbers using the regression equation will be described using FIGS. 11 to 14. Note that in subsequent description, a human motion sensor is installed in the ceiling above each counter in an actual store. Also, description is given using data measured by these human motion sensors.

FIG. 11 is a diagram showing exemplary output of the human motion sensor installed in a given counter. In the example in FIG. 11, the number of times that the human motion sensor detected the movement of people (response frequency: frequency at which the sensor switched from OFF to ON) and the period of time that detection was continued (response time: time that sensor is ON) were aggregated every 10 seconds between 12:00 and 12:30. The aggregated human motion sensor data is shown in FIG. 11.

The method of calculating the regression equation for computing visitor numbers from aggregated human motion sensor data is as follows. In the present Embodiment 1, as shown in FIG. 11, the regression equation is calculated by applying regression analysis to the relationship between the human motion sensor data for the 10 minute interval and the actual visitor numbers during that period. An average value AVEₙ of the response frequency for 10 minutes, a variance value VARₜ likewise of the response frequency, an average value AVEₜ of the response time for 10 minutes, and a variance value VARₜ likewise of the response time are used as human motion sensor data at this time. Also, the average value of visitor numbers measured by actual investigation within this period is used as the “actual visitor number”. The regression equation shown in the following formula 4 is obtained as a result of the regression analysis.

Visitor Number=0.61+0.0014×AVEₜ−0.71×AVEₙ−2.5×10⁻⁷×VARₜ+0.061×VARₙ Formula 4

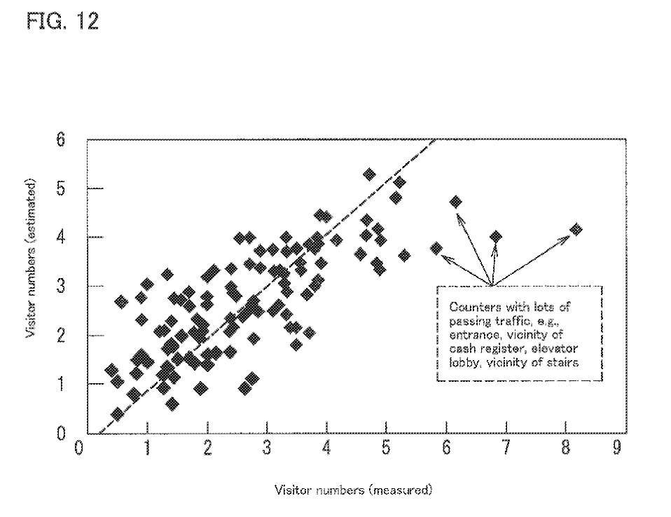

FIG. 12 is a diagram showing the relationship between actual visitor numbers obtained through investigation and visitor numbers computed using the regression equation. As shown in FIG. 12, the actual visitor numbers obtained through investigation and the visitor numbers computed using the regression equation of the above formula 4 generally coincide. This reveals that computation of visitor numbers is possible according to the above formula 4.

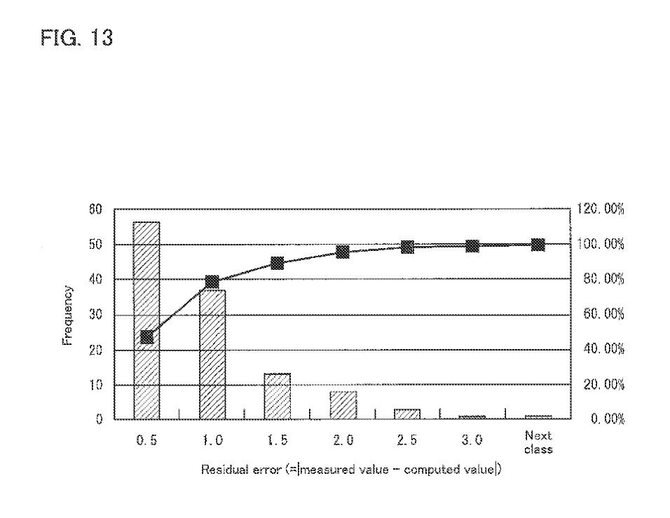

FIG. 13 is a diagram showing the residual error between actual visitor numbers obtained through investigation and computed visitor numbers. In FIG. 13, a bar graph shows the frequency per residual error, and a line graph shows the distribution of residual error. When the distribution of residual error is investigated using FIG. 13, the residual error in approximately 80% of the data is one person. This reveals that visitor numbers can be computed with high accuracy, by using the human motion sensor data shown in FIG. 11.

Also, in the present Embodiment 1, for example, the information acquisition unit 12 preferably collects human motion sensor data and the actual visitor numbers obtained through investigation during the same period, and derives the above regression equation in advance, before actual operation. In that time, human motion sensor data and actual visitor numbers may be collected for the entire store and a single regression equation may be derived, or human motion sensor data and actual visitor numbers may be collected for every counter (every sensor) and regression equations may be derived for every counter. After the regression equation has been derived, the information acquisition unit 12 collects the human motion sensor data every fixed period, and computes the visitor numbers for the same period by applying the derived regression equation.

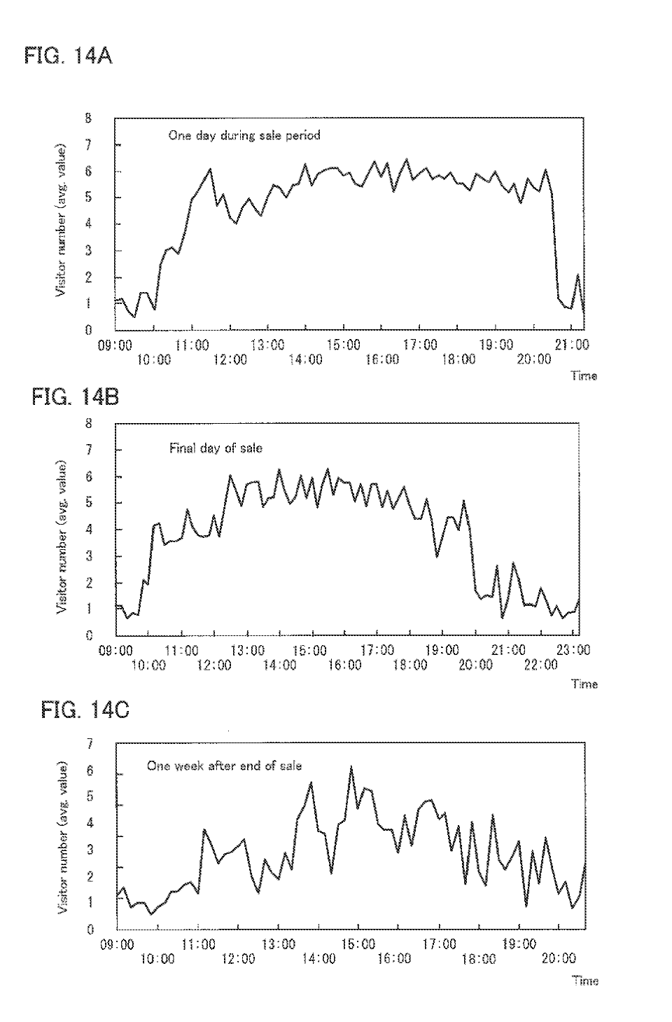

Specific examples of the computation results are shown in FIG. 14A, FIG. 14B, and FIG.14C. FIGS. 14A each show exemplary visitor numbers of a counter computed using a regression equation. In particular, FIG. 14B shows the computation results for visitor numbers during a sale period at a given counter. FIG. 14B shows the computation results for visitor numbers on the final day of the sale. FIG. 14C shows the computation results for visitor numbers one week after the end of the sale.

As shown in FIG. 14A, during the sale period, an average of five to six customers are always at the counter from opening time to closing time. On the other hand, as shown in FIG. 14B, on the final day of the sale, an average of five to six customers are at the counter a little while after opening time, similarly to previous days (see FIG. 14A), but the number of the customers at the counter decreases toward closing time. As shown in FIG. 14C, a week after the end of the sale, visitor numbers remain fairly low, with a maximum of around four to five people during the day.

As described above, in the present Embodiment 1, a regression equation is derived in advance, and visitor numbers for every counter are computed using the derived regression equation. Also, the computed visitor numbers are utilized in calculating the level of interest. Furthermore, the abovementioned methods of calculating the regression equation and computing visitor numbers using a regression equation can be used also in Embodiments 2 and 3 which will be illustrated hereafter.

### Embodiment 2

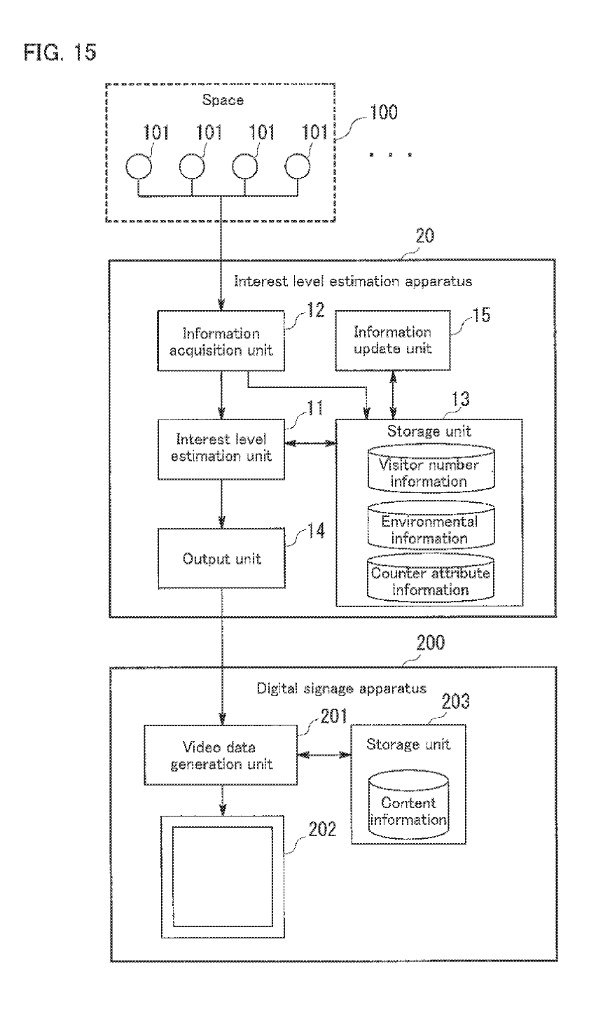

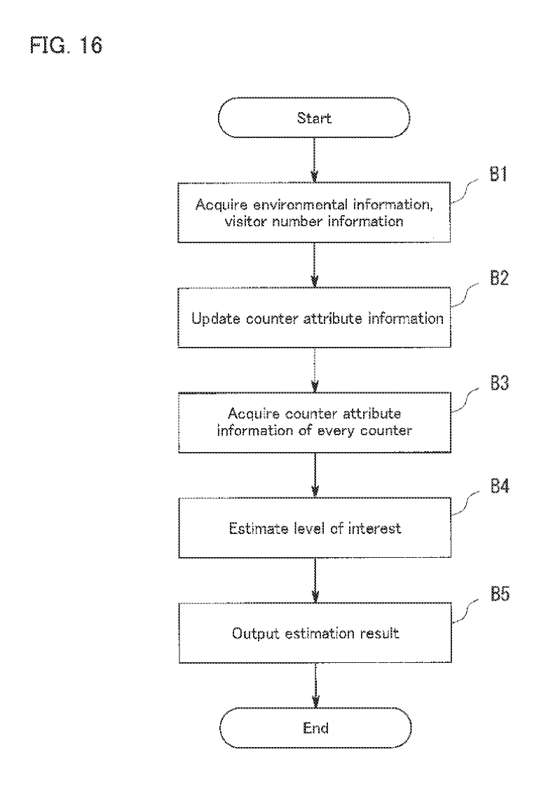

Next, an interest level estimation apparatus, an interest level estimation method and a program in Embodiment 2 of the present invention will be described, with reference to FIGS. 15 and 16.

Apparatus Configuration

Initially, a configuration of an interest level estimation apparatus 20 in the present Embodiment 2 will be described, using FIG. 15. FIG. 15 is a block diagram showing a configuration of the interest level estimation apparatus in Embodiment 2 of the present invention. As shown in FIG. 15, the interest level estimation apparatus 20 in the present Embodiment 2 is provided with an information update unit 15, in addition to the configuration of the interest level estimation apparatus 10 shown in FIG. 1 in Embodiment 1.

Also, in the present Embodiment 2, the spaces targeted for interest level estimation are similarly the spaces 100-1 to 100-4 (see FIG. 2), and a single section of each space similarly corresponds to a single counter. In the present Embodiment 2, the “sections” will also subsequently be referred to as “counters”.

Also, in the present Embodiment 2, on acquisition of environmental information and visitor number information, the information acquisition unit 12 also outputs this information to the storage unit 13 when acquired. The storage unit 13 stores the output environmental information and visitor number information as past information, in addition to position information. The storage unit 13 also stores the average visitor number, average volume and average temperature that are computed from this information.

The information update unit 15 recalculates the average visitor number, average volume and average temperature that are already stored in the storage unit 13, using the visitor number information and environmental information stored in the storage unit 13, and updates these values. Also, in the case where the average visitor number, average volume and average temperature are not stored in the storage unit 13, having not yet been computed, the information update unit 15 newly computes the average visitor number, average volume and average temperature, instead of recalculating.

Note that except for the above points, the interest level estimation apparatus 20 in the present Embodiment 2 is configured similarly to the interest level estimation apparatus 10 shown in FIG. 1 in Embodiment 1. Hereinafter, operations of the interest level estimation apparatus 20 will be described, focusing on the differences from Embodiment 1.

Operations

Operations of the interest level estimation apparatus 20 in the present Embodiment 2 will be described using FIG. 16. FIG. 16 is a flowchart showing operations of the interest level estimation apparatus in the present Embodiment 2. In the following description, FIG. 15 is taken into consideration as appropriate. Also, in the present Embodiment 2, the interest level estimation method is implemented by operating the interest level estimation apparatus 20. Accordingly, description of the interest level estimation method in the present Embodiment 2 is replaced with the following description of operations of the interest level estimation apparatus 20.

As shown in FIG. 16, initially, the information acquisition unit 12 acquires environmental information and visitor number information from each sensor post 101 (step B1). Also, at step B1, the information acquisition unit 12 outputs the acquired environmental information and visitor number information to both the interest level estimation unit 11 and the storage unit 13. The storage unit 13 newly stores the acquired environmental information and visitor number information.

In the present Embodiment 2, step B1 is a similar step to step A1 shown in FIG. 4, and the visitor numbers, volumes and temperatures shown in FIG. 5 are given as specific examples of acquired environmental information and visitor number information. The information acquisition unit 12 then outputs the acquired visitor numbers, volumes and temperatures to the interest level estimation unit 11 and the storage unit 13. The storage unit 13 stores the output visitor numbers, volumes and temperatures as past information.

Next, the information update unit 15 recalculates the average visitor number, average volume and average temperature that are already stored in the storage unit 13, using the visitor number information and environmental information stored in the storage unit 13, and updates these values (step B2).

In step B2, the information update unit 15 is able to recalculate the average visitor number, average volume and average temperature, using following formulas 5 to 7, for example. Recalculation will now be described.

The following formula 5 shows a calculation formula for the average visitor number. In the following formula 5, the average visitor number is calculated from data for the past one month. In the following formula 5, n₁ indicates the number of pieces of data. The information update unit 15 subtracts the value of the oldest visitor number from the “total value of the visitor numbers for one month (Σ_{1 month} visitor num)” in the following formula 5, adds the value of the visitor number newly stored at step B1, and updates the value of the average visitor number using the following formula 5.

$$Average Visitor Number = \frac{1}{{n}_{1}} {\sum }_{1 month} visitor num \qquad Formula 5$$

The following formula 6 shows a calculation formula for average volume. In the following formula 6, the average volume is calculated from data for the past one week. In the following formula 6, n₂ indicates the number of pieces of data. The information update unit 15 subtracts the value of the oldest volume from the “total value of the volumes for one week (Σ_{1 week} vol.)” in the following formula 6, adds the volume newly stored at step B1, and updates the value of average volume using the following formula 6.

$$Average Volume = \frac{1}{{n}_{2}} {\sum }_{1 week} vol . \qquad Formula 6$$

The following formula 7 shows a calculation formula for average temperature. In the following formula 7, the average temperature is calculated from data for the past one week. In the following formula 7, n₃ indicates the number of pieces of data. The information update unit 15 subtracts the value of the oldest temperature from the “total value of the temperatures for one week (Σ_{1 week} volume)” in the following formula 7, adds the temperature newly stored at step B1, and updates the value of average temperature using the following formula 7.

$$Average Temperature = \frac{1}{{n}_{3}} {\sum }_{1 week} temp . \qquad Formula 7$$

Note that although updating is performed using newly stored information whenever step B1 is executed in the example in FIG. 16, the present Embodiment 2 is not limited thereto. For example, a mode may be adopted in which a step of determining whether a setting period has passed is executed between step B1 and step B2, and the update processing of step B2 is executed only in the case where the setting period has passed. Furthermore, a mode may be adopted in which a step of determining whether the current period coincides with the period of an event (Christmas, St Valentine's Day, etc.) is executed between step B1 and step B2, and the update processing of step B2 is executed using past information from the same period in the case where the current period does coincide with such an event.

Next, the interest level estimation unit 11 accesses the storage unit 13 and acquires the counter attribute information of every counter (step B3). Step B3 is a similar step to step A2 shown in FIG. 4. The information shown in FIG. 6 is given as counter attribute information acquired at step B3. The counter attribute information acquired at step B3, however, includes the average visitor number, average volume and average temperature updated in step B2.

Next, the interest level estimation unit 11 estimates the level of interest for every counter, using the environmental information and visitor number information (specifically, visitor number, volume and temperature) acquired at step B1, and the counter attribute information of every counter acquired at step B3 (step B4). Step B4 is a similar step to step A3 shown in FIG. 4. At step B4, however, the interest level estimation unit 11 computes the level of interest using the above formula 2.

Thereafter, the output unit 14 receives the level of interest estimated by the interest level estimation unit 11, and outputs the interest level information specifying the level of interest to the digital signage apparatus 200 (step B5). Step B5 is a similar step to step A4 shown in FIG. 4. Also, in the present Embodiment 2, steps B1 to B5 are similarly performed for every space that requires interest level estimation.

Also, in the present Embodiment 2, after execution of step B5, the digital signage apparatus 200 similarly displays the level of interest on the screen of the display device 202, based on the interest level information output from the output unit 14 of the interest level estimation apparatus 20. The modes shown in FIGS. 7 to 10 are similarly given as modes of displaying the level of interest in the present Embodiment 2.

As described above, in the present Embodiment 2, the level of interest is similarly computed also using elements representing the actual situation such as volume, temperature and position, in addition to the visitor numbers of each counter in the specific space. The level of interest thus serves as an index representing the actual situation, similarly to Embodiment 1. Also, in the present Embodiment 2, since counter attribute information can be easily updated, the level of interest will more closely represent the actual situation.

The program in the present Embodiment 2 may be any program that causes a computer to execute steps B1 to B5 shown in FIG. 16. The interest level estimation apparatus 20 and the interest level estimation method in the present Embodiment 2 can be realized by installing and executing this program on a computer.

In this case, the CPU (Central Processing Unit) of the computer functions as the information acquisition unit 12, the interest level estimation unit 11 and the information update unit 15, and performs processing. Also, an external connection interface of the computer functions as the output unit 14, and a hard disk or the like provided in the computer functions as the storage unit 13.

### Embodiment 3

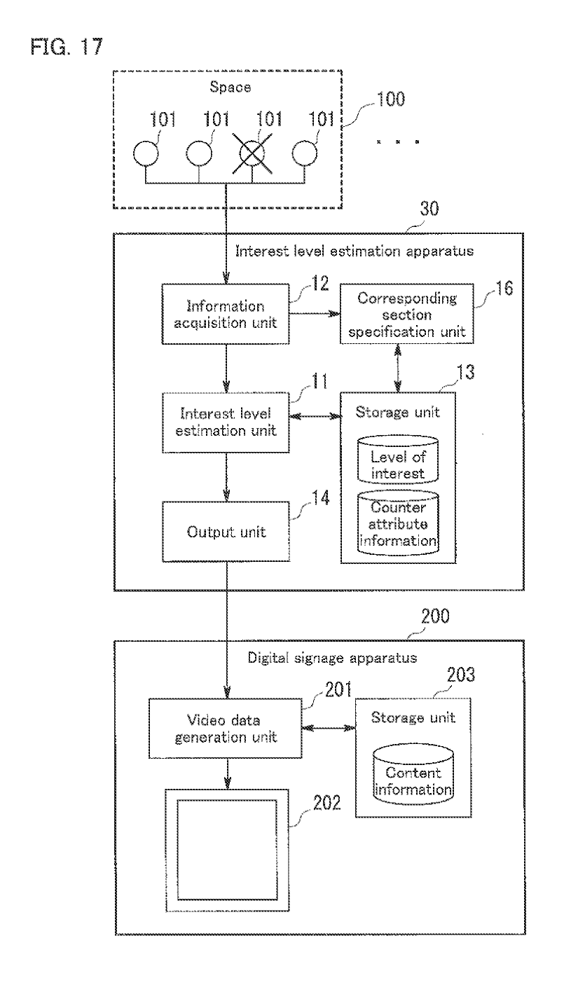

Next, an interest level estimation apparatus, an interest level estimation method and a program in Embodiment 3 of the present invention will be described, with reference to FIGS. 17 to 21.

Apparatus Configuration

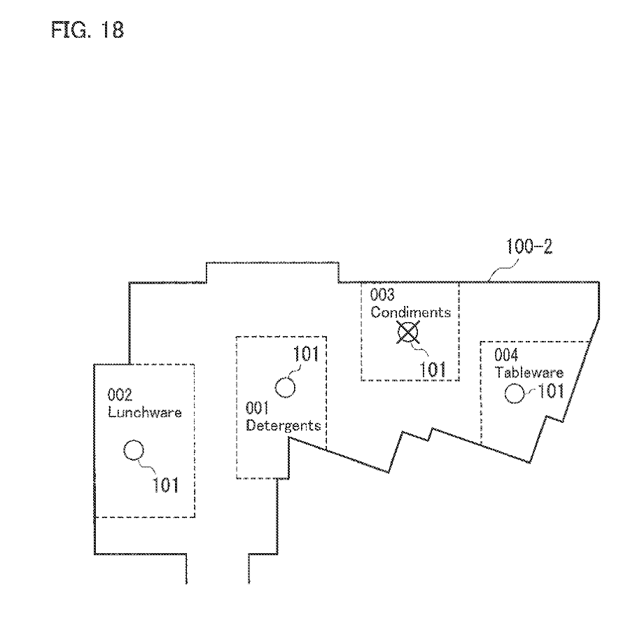

Initially, a configuration of an interest level estimation apparatus 30 in the present Embodiment 3 will be described, using FIGS. 17 and 18. FIG. 17 is a block diagram showing a configuration of the interest level estimation apparatus in the present Embodiment 3 of the present invention. FIG. 18 shows an exemplary space targeted for interest level estimation in Embodiment 3 of the present invention.

As shown in FIG. 17, the interest level estimation apparatus 30 in the present Embodiment 3 is provided with a corresponding section specification unit 16, in addition to the configuration of the interest level estimation apparatus 10 shown in FIG. 1 in Embodiment 1. The corresponding section specification unit 16 specifies other sections corresponding to a section for which interest level estimation cannot be performed, in the case where interest level estimation by the interest level estimation unit 11 cannot be performed in any of the sections in the specific space.

Also, in the present Embodiment 3, the spaces targeted for interest level estimation are similarly the spaces 100-1 to 100-4 (see FIG. 2), and a single section of each space similarly corresponds to a single counter. In the present Embodiment 3, the “sections” will also subsequently be referred to as “counters”.

For example, as shown in FIG. 18, the case where the sensor post 101 disposed at the “condiments counter” of the space 100-2 is faulty is assumed. In this case, since visitor number information, environmental information or both cannot be acquired due to the sensor post 101 being faulty in the “condiments counter”, interest level estimation will not be possible. Therefore, the corresponding section specification unit 16 specifies other counters corresponding to the “condiments counter” for which interest level estimation cannot be performed.

Here, “corresponding other counters” include a counter whose past change in interest level is similar to the counter for which interest level estimation cannot be performed, a counter that is positioned nearby, or a counter whose change in interest level is highly correlated to the change in interest level of the counter concerned (in other words, a counter having a high cosine similarity when counter attributes are represented as a vector).

Also, in the present Embodiment 3, the interest level estimation unit 11 also outputs the estimated level of interest to the storage unit 13, in addition to the output unit 14. The storage unit 13 thus stores the level of interest previously estimated by the interest level estimation unit 11 for every counter.

Also, when the corresponding section specification unit 16 has specified other corresponding counters, the interest level estimation unit 11 extracts the levels of interest previously estimated for the other specified counters from the storage unit 13. The interest level estimation unit 11 then predicts the level of interest of the counter for which interest level estimation cannot be performed, based on the extracted past levels of interest.

For example, in FIG. 18, assume that the corresponding section specification unit 16 (see FIG. 17) specifies a “lunchware counter” and a “detergents counter” as corresponding other counters. In this case, the interest level estimation unit 11 predicts the level of interest of the “condiments counter”, using the past level of interest of the “lunchware counter” and the past level of interest of the “detergents counter”. Note that processing for thus predicting the level of interest for a counter whose sensor post 101 is not functioning is referred to as “prediction processing' in the present Embodiment 3. Also, a specific example of prediction processing will be given in the following description of operations.

In this way, in the present Embodiment 3, even in the case where the sensor post 101 installed in a given counter stops working or the like, and interest level estimation can no longer be performed for that counter, the interest level estimation apparatus 30 is able to predict the level of interest of the counter from the past levels of interest of corresponding other counters.

Note that, except for above points, the interest level estimation apparatus 30 in the present Embodiment 3 is configured similarly to the interest level estimation apparatus 10 shown in FIG. 1 in Embodiment 1. Hereinafter, operations of the interest level estimation apparatus 30 will be described below, focusing on differences from Embodiment 1.

Operations

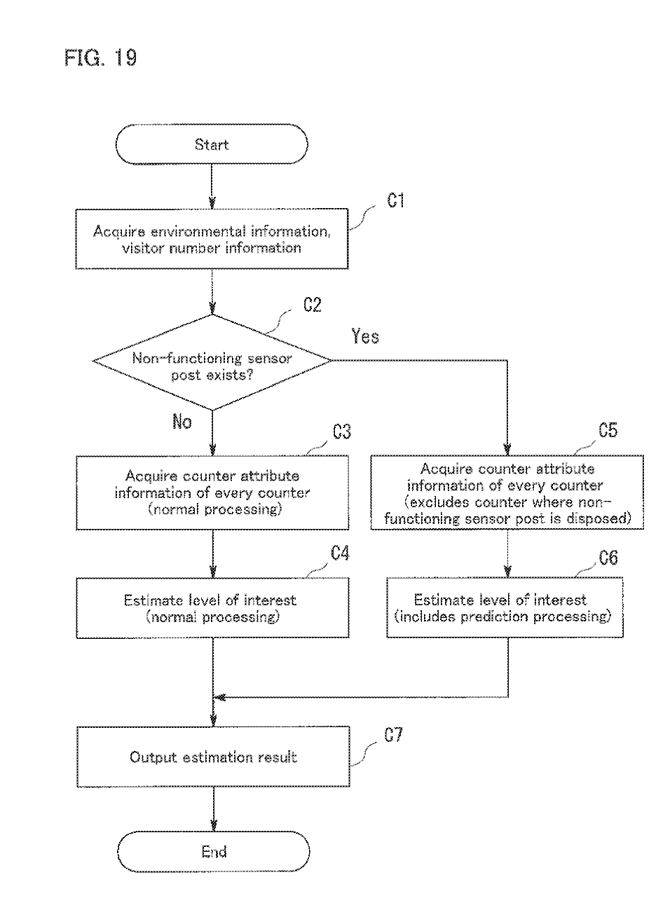

Operations of the interest level estimation apparatus 30 in Embodiment 3 of the present invention will be described using FIGS. 19 to 21. First, the overall operations of the interest level estimation apparatus 30 will be described, based on FIG. 19. FIG. 19 is a flowchart showing operations of the interest level estimation apparatus in Embodiment 3 of the present invention.

In the following description, FIGS. 17 and 18 are taken into consideration as appropriate. Also, in the present Embodiment 3, the interest level estimation method is implemented by operating the interest level estimation apparatus 30. Accordingly, description of the interest level estimation method in the present Embodiment 3 is replaced with the following description of operations of the interest level estimation apparatus 30.

As shown in FIG. 19, initially, the information acquisition unit 12 acquires environmental information and visitor number information from the sensor posts 101 (step C1). Step C1 is a similar step to step A1 shown in FIG. 4. In the present Embodiment 3, the visitor numbers, volumes and temperatures shown in FIG. 5 are similarly given as specific examples of acquired environmental information and visitor number information.

In step C1, the information acquisition unit 12 then outputs the acquired visitor numbers, volumes and temperatures to the interest level estimation unit 11. In the present Embodiment 3, the information acquisition unit 12 also outputs the acquired visitor numbers, volumes and temperatures to the corresponding section specification unit 16.

Next, the corresponding section specification unit 16 determines whether there is a sensor post 101 that is not functioning, based on the output from the information acquisition unit 12 (step C2). Specifically, the corresponding section specification unit 16 specifies the sensor posts 101 that are the output origins of the visitor numbers, volumes and temperatures output by the information acquisition unit 12, and determines whether all the sensor posts 101 in the space 100-2 can be specified.

In the case where, as a result of the determination of step C2, the corresponding section specification unit 16 determines that there are no sensor posts 101 that are not functioning, the interest level estimation unit 11 accesses the storage unit 13 and acquires the counter attribute information of every counter (step C3). Step C3 is a similar step to step A2 shown in FIG. 4. The information shown in FIG. 6 is similarly given as counter attribute information acquired at step C3.

Next, when step C3 has been executed, the interest level estimation unit 11 estimates the level of interest for every counter, using the environmental information and visitor number information (specifically, visitor number, volume and temperature) acquired at step C1, and the counter attribute information of every counter acquired at step C3 (step C4). Step C4 is a similar step to step A3 shown in FIG. 4. At step C4, the level of interest is estimated for all the counters.

After execution of step C4, the output unit 14 then receives the levels of interest estimated by the interest level estimation unit 11, and outputs interest level information specifying the levels of interest to the digital signage apparatus 200 (see FIG. 17) (step C7). Step C7 is a similar step to step A4 shown in FIG. 4.

On the other hand, in the case where, as a result of the determination of the abovementioned step C2, the corresponding section specification unit 16 determines that there is a sensor post 101 that is not functioning, the interest level estimation unit 11 acquires counter attribute information, excluding the counter whose sensor post 101 is not functioning (step C5). Step C5 is performed according to step A2 shown in FIG. 4. In the case of the example in FIG. 18, the interest level estimation unit 11 acquires the counter attribute information of the “lunchware counter”, the “detergents counter” and the “tableware counter”, excluding the “condiments counter”.

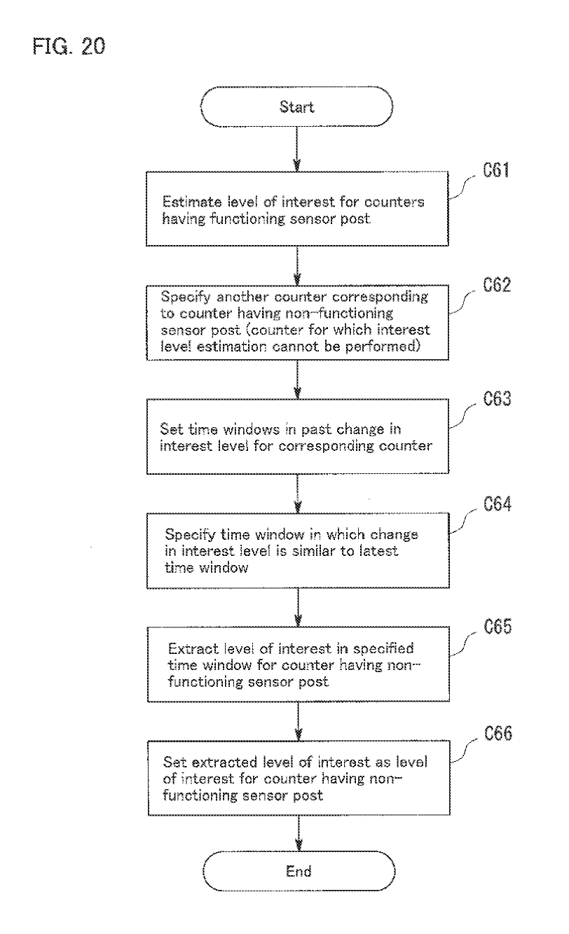

After execution of step C5, the interest level estimation unit 11 estimates the levels of interest for the counters whose sensor post 101 is functioning, similarly to step C4, and predicts the level of interest by prediction processing for any counters whose sensor post 101 is not functioning (step C6). Note that prediction processing will be discussed later using FIG. 20. Thereafter, the abovementioned step C7 is also executed in the case where step C5 and the step C6 are executed. Also, in the present Embodiment 3, steps C1 to C7 are executed for every space that requires interest level estimation.

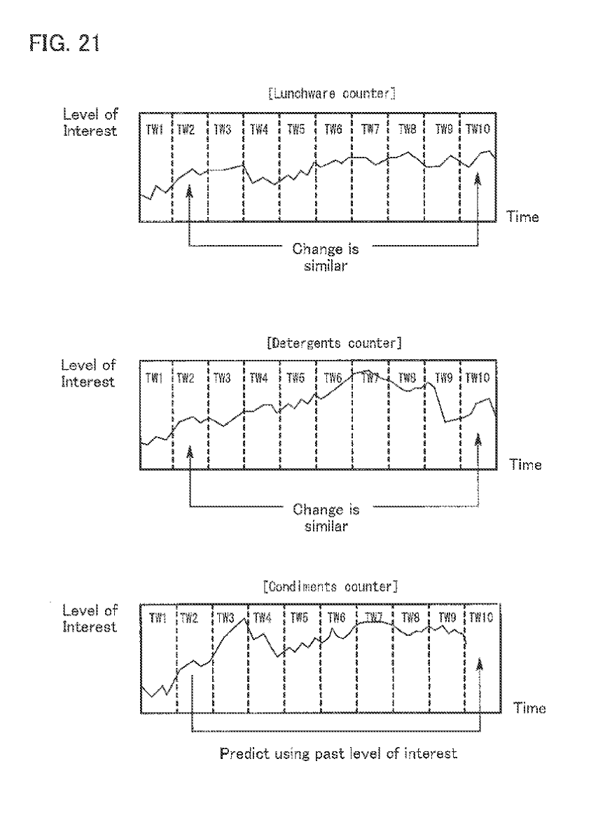

Here, step C6 will be specifically described using FIGS. 20 and 21. FIG. 20 is a flowchart specifically showing the prediction processing shown in FIG. 19. FIG. 21 is an illustrative diagram that specifically illustrates steps C63 and C64 shown in FIG. 20.

As shown in FIG. 20, after execution of step C5 shown in FIG. 19, first, the interest level estimation unit 11 estimates the levels of interest for the counters whose sensor post 101 is functioning (step C61). Step C61 is performed according to step A3 shown in FIG. 4.

Next, the corresponding section specification unit 16 specifies other counters (hereinafter, referred to as “corresponding counters”) corresponding to the counter (hereinafter, referred to as “counter targeted for prediction”) for which the level of interest cannot be estimated because of the sensor post 101 not functioning (step C62). At step C62, the corresponding section specification unit 16 specifies the corresponding counters using, for example, at least one of position information and the levels of interest previously estimated for counters other than the counter targeted for prediction.

Specific methods of specifying a corresponding counter includes the following (1) to (3) or a combination thereof.
(1) Contrast the past change in interest level of the counter targeted for prediction with the past changes in interest level of the other counters, and take the counters whose change has a high correlation with the change of the counter targeted for prediction as corresponding counters.
(2) Take counters whose difference in the line-of-flow distance from the counter targeted for prediction is less than or equal to a threshold value as corresponding counters.
(3) Represent the counter attributes of each counter as a vector, calculate the cosine similarity of the counter attributes of the counter targeted for prediction and the counter attributes of the other counters, and take the top n counters in descending order of cosine similarity as corresponding counters (n: natural number).

Note that the degree of the correlation in (1) above, the threshold value in (2) above, and the value of n in (3) above are set as appropriate according to the actual situation or the like. Also, in the present Embodiment 3, corresponding counters may be determined in advance for every counter. In this case, the corresponding section specification unit 16, having detected a counter whose sensor post 101 is faulty or the like, specifies the predetermined counters as the corresponding counters of that counter.

Next, the interest level estimation unit 11 extracts the past levels of interest of the corresponding counters from the storage unit 13, and sets time windows at set intervals back in time based on the current time, with respect to the levels of interest previously estimated for the corresponding counters (step C63). For example, as shown in FIG. 21, in the case where the “lunchware counter” and the “detergents counter” are specified as corresponding counters, the time windows TW1 to TW10 are set with respect to the past levels of interest of these counters. The time window TW10 is the latest time window among these time windows.

Next, the interest level estimation unit 11 contrasts the change in interest level of the latest time window TW10 with the change in interest level of the time windows other than the latest time window, and specifies a time window whose mode of change is most similar to the latest time window TW10 (step C64).

Specifically, the interest level estimation unit 11 first computes the degree of similarity between the waveform of the level of interest of the latest time window TW10 and the waveforms of the levels of interest of the other time windows for every corresponding counter. The degree of similarity in this case includes, for example, the correlation coefficient or cosine similarity between corresponding time windows. Next, the interest level estimation unit 11 integrates the degrees of similarity of the corresponding counters for every time window, and derives average values thereof. The interest level estimation unit 11 then specifies the time window having the highest average value, and specifies this time window as the time window that is similar to the latest time window TW10. In the example in FIG. 18, the time window TW2 is specified.

Next, the interest level estimation unit 11 extracts the past level of interest for the specified time window (time window TW2 in the example in FIG. 21) of the counter targeted for prediction from the storage unit 13 (step C65), and takes the extracted past level of interest as the current level of interest of the counter targeted for prediction (step C66). Specifically, the interest level estimation unit 11 takes the change in interest level for the time window TW2 directly as the change in interest level for the latest time window TW10. The levels of interest of all the counters will have been estimated by execution of steps C61 to C66.

In the case where one of the sensor posts 101 is faulty or the like, the interest level estimation apparatus 10 in Embodiment 1 will be unable to estimate the level of interest of the counter where the sensor post 101 that is faulty or the like is disposed. In contrast, even if one of the sensor posts 101 is faulty, the interest level estimation apparatus 30 in the present Embodiment 3 is able to predict the level of interest of the counter where that sensor post is disposed from the past level of interest of other counters. According to the present Embodiment 3, in the case where the interest level estimation apparatus is incorporated into a system, stabilization of the system can be achieved.

Also, the program in the present Embodiment 3 may be any program that causes a computer to execute steps C1 to C7 shown in FIG. 19, and steps C61 to C66 shown in FIG. 20. The interest level estimation apparatus 30 and the interest level estimation method in the present Embodiment 3 can be realized by installing and executing this program on a computer.

In this case, the CPU (Central Processing Unit) of the computer functions as the information acquisition unit 12, the interest level estimation unit 11 and the corresponding section specification unit 16, and performs processing. Also, an external connection interface of the computer functions as the output unit 14, and a hard disk or the like provided in the computer functions as the storage unit 13.

### Embodiment 4

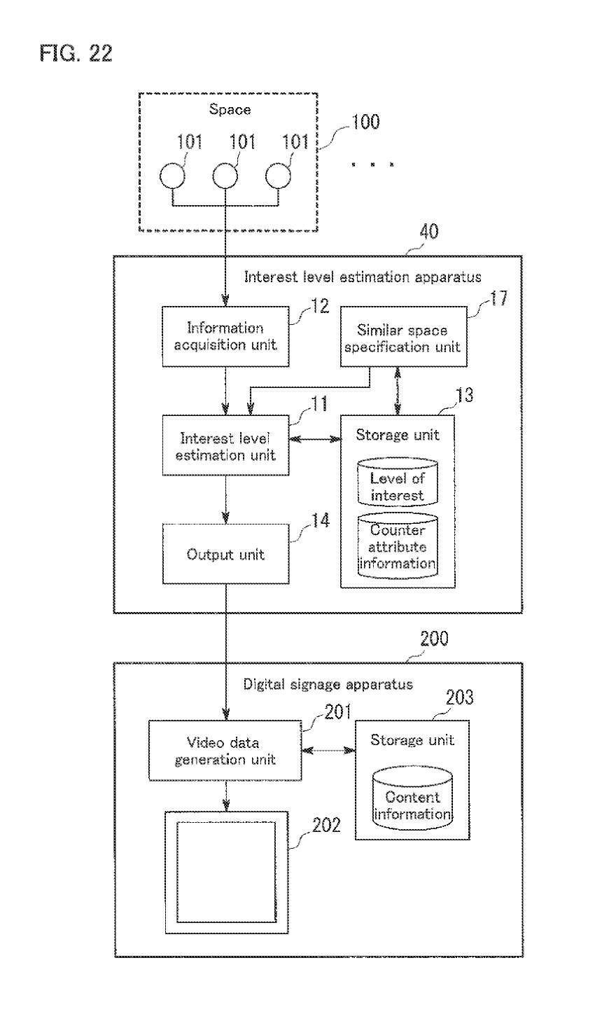

Next, an interest level estimation apparatus, an interest level estimation method, and a program in Embodiment 4 of the present invention will be described, with reference to FIGS. 22 to 27.

Apparatus Configuration

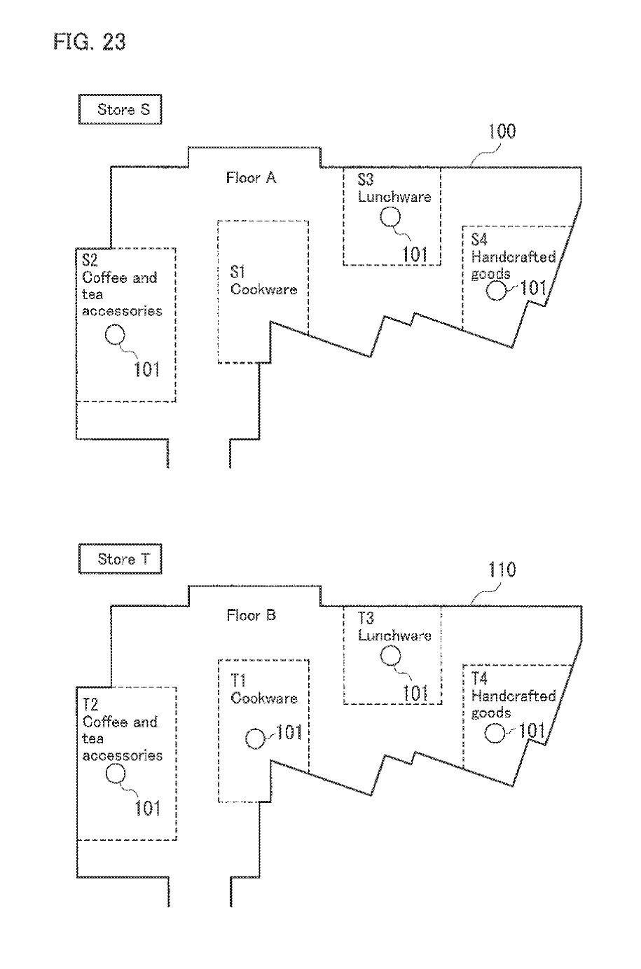

Initially, a configuration of an interest level estimation apparatus 40 in the present Embodiment 4 will be described, using FIGS. 22 and 23. FIG. 22 is a block diagram showing a configuration of the interest level estimation apparatus in Embodiment 4 of the present invention. FIG. 23 shows exemplary spaces targeted for interest level estimation in Embodiment 4 of the present invention.

As shown in FIG. 22, the interest level estimation apparatus 40 in the present Embodiment 4 is provide with a similar space specification unit 17, in addition to the configuration of the interest level estimation apparatus 10 shown in FIG. 1 in Embodiment 1. The similar space specification unit 17 specifies a similar space that is similar to a specific space, among spaces, other than the specific spaces, in which a sensor post 101 is installed (hereinafter, “non-target spaces”).

Also, the interest level estimation unit 11 specifies the sections within a specific space 100, and the correspondence relationship between a non-responding section within the specific space 100 whose sensor post 100 does not respond and responsive sections within a similar space whose sensor post 101 disposed therein does respond. Furthermore, the interest level estimation unit 11 predicts the level of interest of the non-responding section, from the specified correspondence relationship, the level of interest estimated for every section in the specific space 100, and the level of interest estimated for every responsive section within the similar space.

In the present Embodiment 4, prediction processing for predicting the level of interest for a counter in which a sensor post is not disposed is performed in this way. Note that the level of interest estimated for every responsive section within the similar space is also estimated by similar processing to each section within the specific space 100, and indicates the level to which people visiting the responsive sections are interested in the responsive sections. Also, in the present Embodiment 4, a single section of a space similarly corresponds to a single counter. In the present Embodiment 4, the “sections” will also subsequently be referred to as “counters”.

Here, description is given using an example based on FIG. 23. In the example in FIG. 23, the specific space 100 is floor A of store S, and a “cookware counter: S1”, a “coffee and tea accessories counter: S2”, a “lunchware counter: S3” and a “handcrafted goods counter: S4” are installed on floor A. Also, in FIGS. 23, S1, S2, S3 and S4 respectively indicate the identifiers of the counters on floor A.

Sensor posts 101 are installed in the “coffee and tea accessories counter: S2”, the “lunchware counter: S3” and the “handcrafted goods counter: S4”, among the counters on floor A. Thus, the interest level estimation unit 11 estimates the level of interest for the “coffee and tea accessories counter: S2”, the “lunchware counter: S3”, and the “handcrafted goods counter: S4”. On the other hand, the “cookware counter: S1” on floor A is installed in a place where a sensor post 101 is not disposed. On floor A, the “cookware counter: S1” is a non-responding section and is targeted for prediction by the interest level estimation apparatus 40.

Also, in the example in FIG. 23, the similar space specification unit 17 specifies floor B of store T as a similar space of the specific space 100. Also, a “cookware counter: T1”, a “coffee and tea accessories counter: T2”, a “lunchware counter: T3”, and a “handcrafted goods counter: T4” are installed on floor B. In FIGS. 23, T1 to T4 respectively indicate the identifiers of the counters on floor B.

Also, on floor B, sensor posts 101 are disposed at all the counters, and all the counters are responsive sections. On floor B, the level of interest is respectively estimated for the “cookware counter: T1”, the “coffee and tea accessories counter: T2”, the “lunchware counter: T3”, and the “handcrafted goods counter: T4”.

In the example in FIG. 23, the interest level estimation unit 11 first derives the correspondence relationship between each counter on floor A and each counter on floor B. The interest level estimation unit 11 then predicts the level of interest of the “cookware counter” on floor A, which is a non-responding section, from the correspondence relationship, the level of interest estimated for every counter on floor A, and the level of interest estimated for every counter on floor B which is the similar space.

In this way, in the present Embodiment 4, even if there is a counter where a sensor post 101 is not disposed, the interest level estimation apparatus 40 is able to predict the level of interest of that counter, using the level of interest estimated for other counters on the same floor and for counters of other stores.

In the present Embodiment 4, exemplary non-target spaces include a floor of a different store from store S constituting the specific space 100 (see FIG. 23), and a floor other than floor A in store S constituting the specific space 100. Also, the level of interest of each counter in a non-target space (similar space) may be estimated by the interest level estimation apparatus 40 in the present Embodiment 4, or may be estimated by an interest level estimation apparatus other than the interest level estimation apparatus 40.

Note that, except for the above points, the interest level estimation apparatus 40 in the present Embodiment 4 is configured similarly to the interest level estimation apparatus 10 shown in FIG. 1 in Embodiment 1. Hereinafter, operations of the interest level estimation apparatus 40 will be described, taking the case where specific space is floor A of store S as an example.

Operations

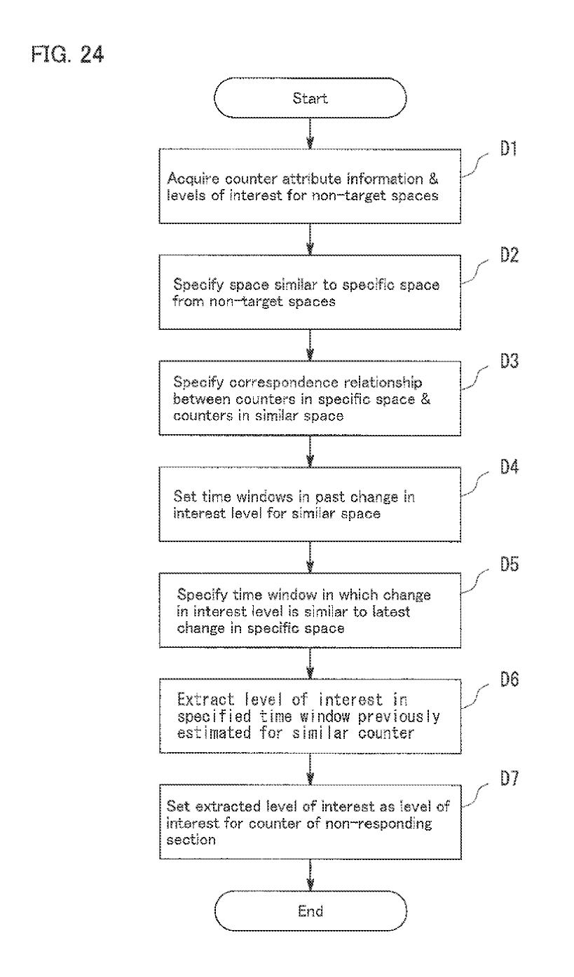

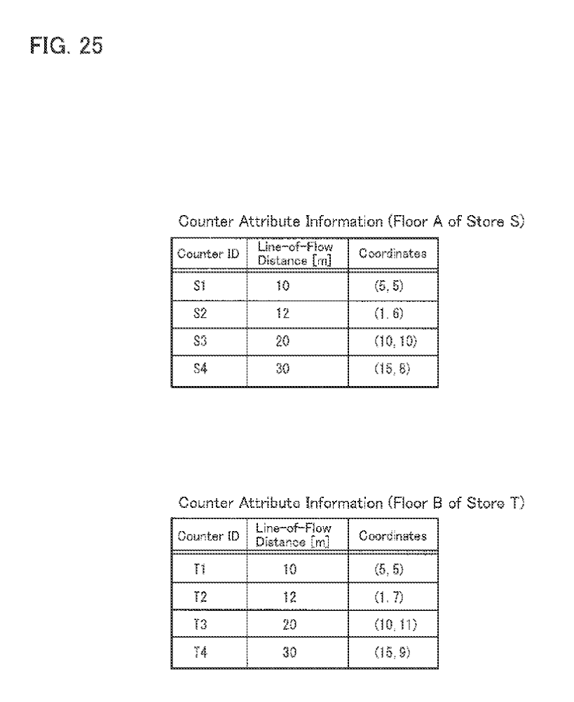

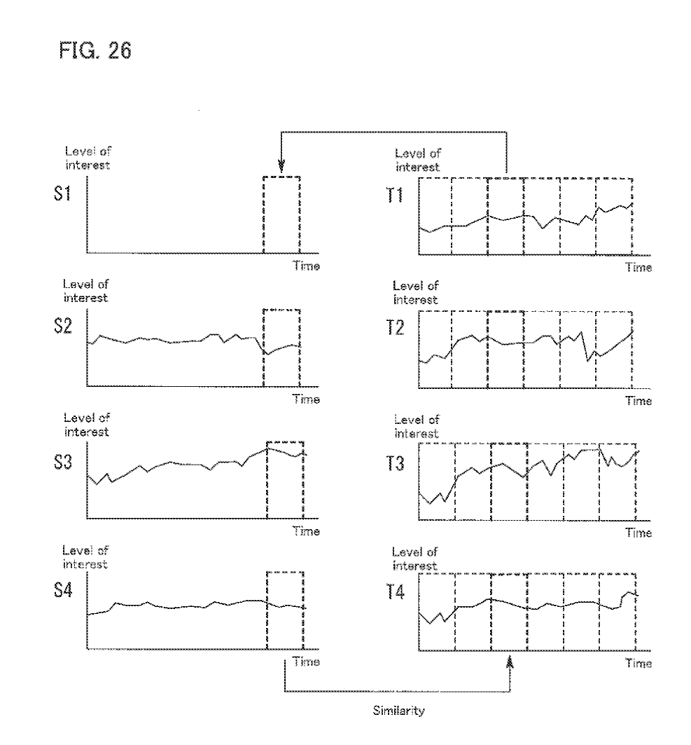

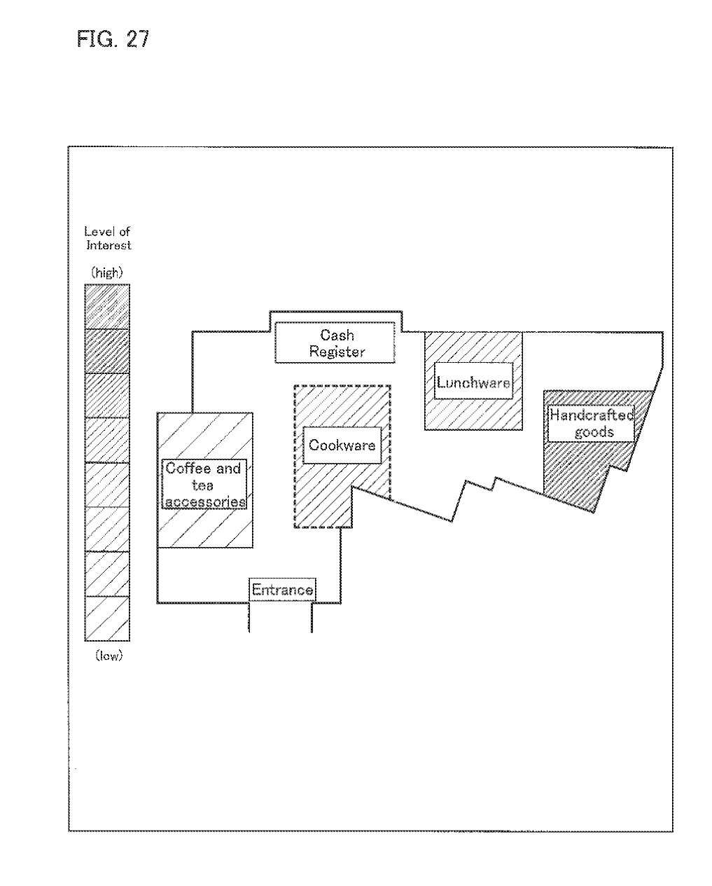

Operations of the interest level estimation apparatus 40 in Embodiment 4 of the present invention will be described using FIGS. 24 to 27. FIG. 24 is a flowchart showing operations of the interest level estimation apparatus in Embodiment 4 of the present invention. FIG. 25 is a diagram respectively showing exemplary counter attribute information for floor A and floor B shown in FIG. 23. FIG. 26 is a diagram respectively showing exemplary changes in the level of interest on floor A and floor B shown in FIG. 23. FIG. 27 is a diagram showing exemplary interest level display mode in Embodiment 4 of the present invention.

In the following description, FIGS. 22 and 23 are taken into consideration as appropriate. Also, in the present Embodiment 4, the interest level estimation method is implemented by operating the interest level estimation apparatus 40. Accordingly, description of the interest level estimation method in the present Embodiment 4 is replaced with the following description of operations of the interest level estimation apparatus 40.

Initially, in the present Embodiment 4, the interest level estimation apparatus 40 executes the steps A1 to A4 shown in FIG. 4 in Embodiment 1, and estimates the level of interest for every of the “coffee and tea accessories counter”, the “lunchware counter”, and the “handcrafted goods counter” on floor A which is the specific space 100. Also, the interest level estimation unit 11 stores the estimated level of interest in the storage unit 13 in time series for every counter. Thereafter, the processing shown in FIG. 24 is executed.

As shown in FIG. 24, first, the similar space specification unit 17 acquires the counter attribute information of each counter in the non-target space and the level of interest previously estimated for every counter (step D1). For example, in the case where a non-target space is targeted for estimation by a different interest level estimation apparatus from the interest level estimation apparatus 40, the similar space specification unit 17 accesses the other interest level estimation apparatus, and acquires the estimated level of interest and the counter attribute information of the counters whose level of interest was estimated from that interest level estimation apparatus.

Also, in the case where the non-target spaces are other specific spaces targeted for estimation by the interest level estimation apparatus 40 (see FIG. 2), the similar space specification unit 17 accesses the storage unit 13, and acquires the counter attribute information and the estimated level of interest for the counters of the other specific spaces.

Next, the similar space specification unit 17 specifies a similar space that is similar to the specific space 100 (floor A of store S), among the non-target spaces (step D2). At step D2, for example, the similar space specification unit 17 derives the degree of similarity of the specific space and each non-target space (hereinafter, referred to as “space similarity”) using the following formula 8, and takes the non-target space with the highest space similarity as the similar space. Note that, in the present Embodiment 4, it is assumed, as mentioned above, that floor B of store T is specified as the similar space from the computation result of the following formula 8.

Space Similarity=a×counter attribute similarity+b×interest level change similarity Formula 8

In the above formula 8, the “counter attribute similarity” can be derived by the following procedures (x1) and (y1). (x1) First, the similar space specification unit 17 derives the cosine similarities with each counter of the non-target spaces, for every counter of the specific space 100, and specifies the combination having the highest cosine similarity. (y1) Then, the similar space specification unit 17 adds together the cosine similarities of combinations derived in the above (x1) for every non-target space, and takes the obtained value as the “counter attribute similarity” in the above formula 8.

For example, assume that the counter attributes on floor A of store S which is the specific space 100 and counter attributes on floor B of store T which is the non-target space are as shown in FIG. 25. In FIG. 25, the vector representation of the “coffee and tea accessories counter: S2” on floor A are (12, 1, 6), for example. On the other hand, the vector representations of each of the counters on floor B are S (10, 5, 5), S2: (12, 1, 7), S3: (20, 10, 11) and S4: (30, 15, 9). Accordingly, with regard to the “coffee and tea accessories counter: S2” on floor A, the cosine similarity will be maximized when combined with the “coffee and tea accessories counter: T2” on floor B.

Similarly, with regard to the “cookware counter: S1” on floor A, the cosine similarity will be maximized when combined with the “cookware counter: T1” on floor B. Also, with regard to the “lunchware counter: S3” on floor A, the cosine similarity will be maximized when combined with the “lunchware counter: T3” on floor B. Furthermore, with regard to the “handcrafted goods counter: S4” on floor A, the cosine similarity will be maximized when combined with the “handcrafted goods counter: T4” on floor B. If the cosine similarities of the obtained combinations are added together, the “counter attribute similarity” between the floor A of store S and floor B of store T is derived.

Also, in the above formula 8, the “interest level change similarity” can be derived by the following procedures (x2) and (y2). (x2) First, the similar space specification unit 17 derives the interest level change similarity, for every combination derived by above (x1), using the correlation coefficient or the cosine similarity. Note that (x2) is performed according to step C64 shown in FIG. 18. (y2) Then, the similar space specification unit 17 adds together the degrees of similarity of the combinations derived by the above (x2) for every non-target space, and takes the obtained value as the “interest level change similarity” in the above formula 8.

Furthermore, in the above formula 8, a and b are weight coefficients. The weight coefficients a and b are set as appropriate within a defined range (e.g., range of 0 to 1), according to the actual situation, that is, according to the element that is given importance.

Next, the interest level estimation unit 11 specifies the correspondence relationship between floor A of store S which is the specific space 100 and floor B of store T which is the similar space (step D3). In the present Embodiment 4, the interest level estimation unit 11 specifies counters on floor B of store T that are similar to counters on floor A of store S as correspondence relationships, using the position information of each counter on floor A of store S (including position information of “cookware counter: S1” which is a non-responding section), and the position information of each counter (responsive section) on floor B of store T. In other words, the counters on floor B that are respectively similar to the “coffee and tea accessories counter”, the “lunchware counter” and the “handcrafted goods counter” on floor A whose level of interest has already been estimated and the counter on floor B that is similar to the “cookware counter” on floor A whose level of interest has not been estimated are specified.

Specifically, in the present Embodiment 4, the interest level estimation unit 11 is able to use the combinations specified by the similar space specification unit 17 in (x1) of step D2 directly as “correspondence relationships”.

Next, the interest level estimation unit 11 accesses the storage unit 13 and extracts the level of interest previously estimated for every counter (responsive section) within the similar space. As shown in FIG. 26, the interest level estimation unit 11 then sets time windows at set intervals back in time based on the current time, with respect to extracted levels of interest (step D4). Step D4 is a similar step to step C63 shown in FIG. 18. The change in interest level of each counter on floor B which is the similar space and the set time windows are shown on the right-hand side of FIG. 26. Also, the change in interest level of each counter on floor A and the latest time window are shown on the left-hand side of FIG. 26.

Next, the interest level estimation unit 11 contrasts the change in interest level for every counter on floor B in each time window with the latest change in interest level estimated for every counter on floor A (except for the “cookware counter” which is a non-responding section). As shown in FIG. 26, the interest level estimation unit 11 then specifies a time window in which the mode of change in interest level for every counter on floor B is most similar to the latest change in interest level on floor A (step D5).

Specifically, the interest level estimation unit 11 first computes, for every time window, the degree of similarity of interest level waveforms with respect to each combination obtained by (x1) of step D2. In other words, the interest level estimation unit 11, for example, contrasts the interest level waveform for the latest time window of the “coffee and tea accessories counter: S2” with the interest level waveform for every time window of the “coffee and tea accessories counter: T2”, and computes the degree of similarity for every time window. The interest level estimation unit 11 then computes, with respect to each time window, the average value of the degrees of similarity for every combination, and specifies the time window having the highest average value as the time window that is most similar. Note that the degree of similarity in this case also includes the correlation coefficient or cosine similarity between corresponding time windows, similarly to step C64 shown in FIG. 20.

Next, the interest level estimation unit 11 extracts the level of interest (change in interest level) estimated for the “cookware counter: T1” in the time window specified at step D5 from the storage unit 13, given that the counter similar to the “cookware counter: S1” targeted for prediction is the “cookware counter: T1”. The interest level estimation unit 11 then takes the extracted level of interest as the level of interest of the “cookware counter: S1” targeted for prediction (step D7).

In this way, the level of interest of a counter where a sensor post 101 is not disposed is predicted by execution of steps D1-D7. Also, as shown in FIG. 27, in the present Embodiment 4, the space targeted for interest level estimation and the counters constituting that space are displayed on the screen of the display device 202 (see FIG. 22), similarly to Embodiment 1, and the level of interest for every counter is represented by a color, a pattern or the like. In the present Embodiment 4, however, with regard to the counter for which the level of interest was predicted, the level of interest is represented in a different display mode from other counters, so that the user is able to distinguish that counter from other counters. In the example in FIG. 27, the frame of the cookware counter is a dashed line, and the display mode of the cookware counter differs from that of other counters.

Also, the program in the present Embodiment 4 may be any program that causes a computer to execute steps D1 to D7 shown in FIG. 24. The interest level estimation apparatus 40 and the interest level estimation method in the present Embodiment 4 can be realized by installing and executing this program on a computer.

In this case, the CPU (Central Processing Unit) of the computer functions as the information acquisition unit 12, the interest level estimation unit 11 and the similar space specification unit 17, and performs processing. Also, an external connection interface of the computer functions as the output unit 14, and a hard disk or the like provided in the computer functions as the storage unit 13.

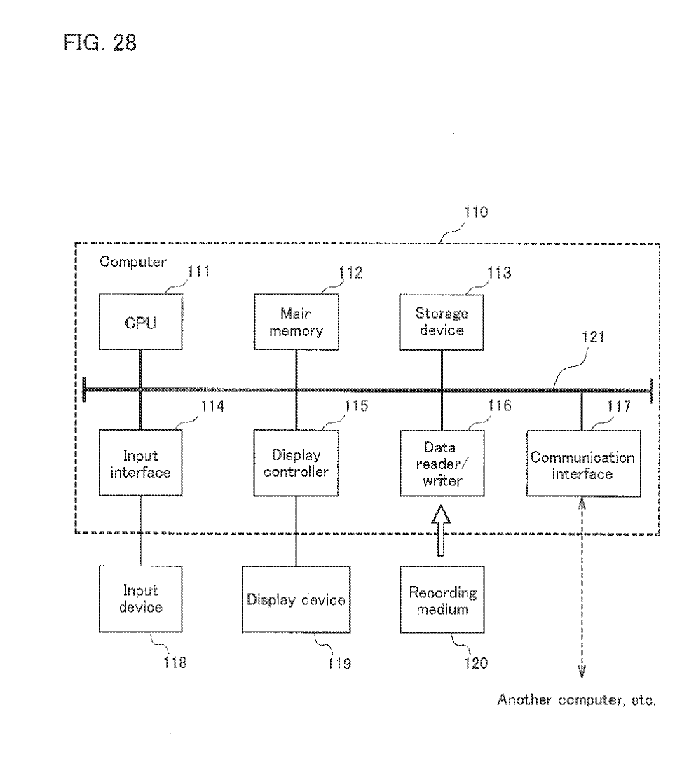

Here, a computer that realizes the interest level estimation apparatuses, by executing the programs of the abovementioned Embodiments 1 to 4 will be described using FIG. 28. FIG. 28 is a block diagram showing an exemplary computer that realizes the interest level estimation apparatuses of Embodiments 1 to 4 of the present invention.

As shown in FIG. 28, a computer 110 is provided with a CPU 111, a main memory 112, a storage device 113, an input interface 114, a display controller 115, a data reader/writer 116, and a communication interface 117. These units are connected to each other so as to enable data communication via a bus 121.

The CPU 111 implements various types of arithmetic operations, by expanding the programs (codes) of the embodiments stored in the storage device 113 in the main memory 112, and executing these programs in a predetermined order. Typically, the main memory 112 is a volatile storage device such as DRAM (Dynamic Random Access Memory). Also, the programs in the embodiments are provided in a state of being stored on a computer-readable recording medium 120. Note that the programs in the embodiments may be circulated on the Internet connected via the communication interface 117.

Also, apart from a hard disk, examples of the storage device 113 include a semiconductor memory device such as a flash memory. The input interface 114 mediates data transmission between the CPU 111 and an input device 118 such as a keyboard or a mouse. The display controller 115 is connected to a display device 119 and controls display performed on the display device 119. The data reader/writer 116 mediates data transmission between the CPU 111 and the recording medium 120, and executes reading of programs from the recording medium 120, and the writing of the results of processing in the computer 110 to the recording medium 120. The communication interface 117 mediates data transmission between the CPU 111 and other computers.

Also, specific examples of the recording medium 120 include a general-purpose semiconductor memory device such as CF (Compact Flash) or SD (Secure Digital), a magnetic storage medium such as a flexible disk, or an optical storage medium such CD-ROM (Compact Disk Read Only Memory).

Note that although the computer 110 is a stand-alone device in the example in FIG. 28, Embodiments 1 to 4 are not limited to this mode. In Embodiments 1 to 4, the computer 110 may be a computer constituting part of the digital signage device 200 (see FIG. 1, etc.), for example.

The abovementioned embodiments, although represented partially or entirely by notes 1 to 15 described below, are not limited to the following descriptions.

Note 1

An interest level estimation apparatus includes an interest level estimation unit that, using at least one of environmental information specifying an environment of every section within a specific space and position information specifying a position of every section, and visitor number information specifying, for every section, the number of people visiting the section, estimates, for every section, a level of interest indicating a level to which people visiting the section are interested in the section.

Note 2

In the interest level estimation apparatus according to note 1 further includes an information acquisition unit that acquires the environmental information from an environmental sensor installed for every section, and acquires the visitor number information from a human motion sensor installed for every section, the environmental information is information specifying at least one of sound volume for every section and temperature for every section, and the interest level estimation unit estimates the level of interest for every section, using the environmental information and the visitor number information acquired by the information acquisition unit.

Note 3

In the interest level estimation apparatus according to note 2, the information acquisition unit acquires the visitor number information, by acquiring a response frequency and a response time of the human motion sensor, and applying the acquired response time and response time to a regression equation that is created in advance, and the regression equation is created by regression analysis of a relationship between information obtained from response frequencies and response times of the human motion sensor in a set period and the number of people measured during the set period in a section where the human motion sensor is installed.

Note 4

In the interest level estimation apparatus according to note 3, the regression equation includes, as variables, an average value and a variance value of response frequencies of the human motion sensor in a fixed period, and an average value and a variance value of response times of the human motion sensor in the fixed period, and the information acquisition unit acquires the visitor number information, by computing the average value and the variance value of response frequencies of the human motion sensor in a fixed period and the average value and the variance value of response times of the human motion sensor in the fixed period, from the acquired response frequency and response time, and applying the computed values to the regression equation.

Note 5

The interest level estimation apparatus according to note 1 further includes an information acquisition unit that acquires the visitor number information from a human motion sensor installed for every section, and a storage unit that stores the position information, and the interest level estimation unit estimates the level of interest for every section, using the position information stored in the storage unit and the visitor number information acquired by the information acquisition unit.

Note 6

In the interest level estimation apparatus according to note 5, the information acquisition unit acquires the visitor number information, by acquiring a response frequency and a response time of the human motion sensor, and applying the acquired response time and response time to a regression equation that is created in advance, and the regression equation is created by regression analysis of a relationship between information obtained from response frequencies and response times of the human motion sensor in a set period and the number of people measured during the set period in a section where the human motion sensor is installed.

Note 7

In the interest level estimation apparatus according to note 6, the regression equation includes, as variables, an average value and a variance value of response frequencies of the human motion sensor in a fixed period, and an average value and a variance value of response times of the human motion sensor in the fixed period, and the information acquisition unit acquires the visitor number information, by computing the average value and the variance value of response frequencies of the human motion sensor in a fixed period and the average value and the variance value of response times of the human motion sensor in the fixed period, from the acquired response frequency and response time, and applying the computed values to the regression equation.

Note 8

In the interest level estimation apparatus according to any of notes 5 to 7, the information acquisition unit further acquires the environmental information from an environmental sensor installed for every section, the environmental information is information specifying at least one of sound volume for every section and temperature for every section, and the interest level estimation unit estimates the level of interest for every section, further using the environmental information acquired by the information acquisition unit.

Note 9 In the interest level estimation apparatus according to note 8, the environmental information is information specifying at least the sound volume for every section, the position information is a distance, in every section, from an entrance of the specific space to the section, and the interest level estimation unit computes the level of interest for every section, from a value obtained by multiplying the number of people visiting the section by a weight coefficient, a value obtained by multiplying a ratio of the distance for the section relative to a total value of the distances for all the sections in the specific space by a weight coefficient, and a value obtained by multiplying the sound volume for the section by a weight coefficient.

Note 10

In the interest level estimation apparatus according to note 8, the environmental information is information specifying the sound volume for every section and the temperature for every section, the position information is a distance, in every section, from an entrance of the specific space to the section, the storage unit further stores a lowest value, for every section, of the number of people visiting the section previously acquired by the information acquisition unit, a reference sound volume set in advance for sound volume, and a reference temperature set in advance for temperature, and the interest level estimation unit computes the level of interest for every section, from a value obtained by multiplying a ratio of the number of people visiting the section relative to the lowest value by a weight coefficient, a value obtained by multiplying a ratio of the distance for the section relative to a total value of the distances for all the sections in the specific space by a weight coefficient, a value obtained by multiplying a ratio of the sound volume for the section relative to the reference sound volume by a weight coefficient, and a value obtained by multiplying a ratio of the temperature for the section relative to the reference temperature by a weight coefficient.

Note 11

In the interest level estimation apparatus according to note 8, the environmental information is information specifying the sound volume for every section and the temperature for every section, the position information is a distance, in every section, from an entrance of the specific space to the section, the storage unit further stores an average value, for every section, of the numbers of people visiting the section previously acquired by the information acquisition unit, an average value, for every section, of sound volumes previously acquired by the information acquisition unit, and an average value, for every section, of temperatures previously acquired by the information acquisition unit, and the interest level estimation unit computes the level of interest for every section, from a value obtained by multiplying a difference between the number of people visiting the section and the average value of the numbers of people by a weight coefficient, a value obtained by multiplying a ratio of the distance for the section relative to a total value of the distances for all the sections in the specific space by a weight coefficient, a value obtained by multiplying a difference between the sound volume for the section and the average value of sound volumes by a weight coefficient, and a value obtained by multiplying a difference between the temperature for the section and the average value of temperatures by a weight coefficient.

Note 12

In the interest level estimation apparatus according to note 11, the information acquisition unit, on acquiring the visitor number information and the environmental information, stores the acquired information in the storage unit, and the interest level estimation apparatus further includes an information update unit that recalculates the average value of the numbers of people, the average value of sound volumes, and the average value of temperatures stored in the storage unit, using the visitor number information and the environmental information that was stored in the storage unit.

Note 13

The interest level estimation apparatus according to any of notes 5 to 12 further includes a corresponding section specification unit that, in a case where interest level estimation by the interest level estimation unit cannot be performed in any one of the sections within the specific space, specifies another section corresponding to the section for which the interest level estimation cannot be performed, the storage unit stores, for every section, the level of interest previously estimated by the interest level estimation unit, and the interest level estimation unit predicts the level of interest for the section for which the interest level estimation cannot be performed, based on the previously estimated level of interest for the corresponding other section specified by the corresponding section specification unit.

Note 14

In the interest level estimation apparatus according to note 13, the corresponding section specification unit specifies the corresponding other section, using at least one of the level of interest previously estimated for sections other than the section for which the interest level estimation cannot be performed, and the position information, and the interest level estimation unit sets time windows at set intervals back in time based on the current time, with respect to the previously estimated level of interest stored, for the corresponding other section, in the storage unit, specifies a time window in which a mode of change is most similar to a latest time window, by contrasting a change in interest level of the latest time window with a change in interest level in time windows other than the latest time window, extracts the past level of interest of the specified time window for the section for which the interest level estimation cannot be performed from the storage unit, and takes the extracted past level of interest as a current level of interest for the section for which the interest level estimation cannot be performed.

Note 15

The interest level estimation apparatus according to any of notes 5 to 14 further includes a similar space specification unit that specifies a similar space that is similar to the specific space, among spaces, other than the specific space, in which a human motion sensor is installed, the interest level estimation unit specifies the sections within the specific space and a correspondence relationship between a non-responding section, within the specific space, whose human motion sensor does not respond and a responsive section, within the similar space, whose human motion sensor disposed therein does respond, and predicts the level of interest in the non-responding section, using the correspondence relationship, the level of interest estimated for every section in the specific space, and a level, estimated for every responsive section within the similar space, to which people visiting the responsive section are interested in the responsive section.

Note 16

In the interest level estimation apparatus according to note 15, the interest level estimation unit, using the position information of the specific space, information specifying a position of the non-responding section within the specific space, and information specifying a position of each responsive section in the similar space, specifies, as the correspondence relationship, the responsive sections within the similar space that are respectively similar to the sections within the specific space and the responsive section within the similar space that is similar to the non-responding section.

Note 17

In the interest level estimation apparatus according to note 16, the storage unit stores the level previously estimated for every responsive section in the similar space, and the interest level estimation unit sets time windows at set intervals back in time based on the current time, with respect to the previously estimated level stored, for every responsive section in the similar space, in the storage unit, specifies a time window in which a mode of change is most similar to a latest change in interest level estimated for every section within the specific space, by contrasting a change in the level in each time window for every responsive section with the latest change, extracts the level of the specified time window estimated for the responsive section that is similar to the non-responding section from the storage unit, and takes the extracted level as the level of interest for the non-responding section.

Note 18

An interest level estimation method includes an interest level estimation step of using at least one of environmental information specifying an environment of every section within a specific space and position information specifying a position of every section, and visitor number information specifying, for every section, the number of people visiting the section, to estimate, for every section, a level of interest indicating a level to which people visiting the section are interested in the section.

Note 19

The interest level estimation method according to note 18 further includes an information acquisition step of acquiring the environmental information from an environmental sensor installed for every section, and acquiring the visitor number information from a human motion sensor installed for every section, the environmental information is information specifying at least one of sound volume for every section and temperature for every section, and in the interest level estimation step, the level of interest is estimated for every section, using the environmental information and the visitor number information acquired in the information acquisition step.

Note 20

In the interest level estimation method according to note 19, in the information acquisition step the visitor number information is acquired, by acquiring a response frequency and a response time of the human motion sensor, and applying the acquired response time and response time to a regression equation that is created in advance, and the regression equation is created by regression analysis of a relationship between information obtained from response frequencies and response times of the human motion sensor in a set period and the number of people measured during the set period in a section where the human motion sensor is installed.

In the interest level estimation method according to note 20, the regression equation includes, as variables, an average value and a variance value of response frequencies of the human motion sensor in a fixed period, and an average value and a variance value of response times of the human motion sensor in the fixed period, and in the information acquisition step the visitor number information is acquired, by computing the average value and the variance value of response frequencies of the human motion sensor in a fixed period and the average value and the variance value of response times of the human motion sensor in the fixed period, from the acquired response frequency and response time, and applying the computed values to the regression equation.

Note 22

The interest level estimation method according to note 18 further includes an information acquisition step of acquiring the visitor number information from a human motion sensor installed for every section, and the position information is stored in advance in a storage device, and in the interest level estimation step the level of interest for every section is estimated, using the position information stored in the storage device and the visitor number information acquired in the information acquisition step.

Note 23

In the interest level estimation method according to note 22, in the information acquisition step the visitor number information is acquired, by acquiring a response frequency and a response time of the human motion sensor, and applying the acquired response time and response time to a regression equation that is created in advance, and the regression equation is created by regression analysis of a relationship between information obtained from response frequencies and response times of the human motion sensor in a set period and the number of people measured during the set period in a section where the human motion sensor is installed.

Note 24

In the interest level estimation method according to note 23, the regression equation includes, as variables, an average value and a variance value of response frequencies of the human motion sensor in a fixed period, and an average value and a variance value of response times of the human motion sensor in the fixed period, and in the information acquisition step the visitor number information is acquired, by computing the average value and the variance value of response frequencies of the human motion sensor in a fixed period and the average value and the variance value of response times of the human motion sensor in the fixed period, from the acquired response frequency and response time, and applying the computed values to the regression equation.

Note 25

In the interest level estimation method according to any of notes 22 to 24, in the information acquisition step the environmental information is further acquired from an environmental sensor installed for every section, the environmental information is information specifying at least one of sound volume for every section and temperature for every section, and in the interest level estimation step the level of interest is estimated for every section, further using the environmental information acquired in the information acquisition step.

Note 26

In the interest level estimation method according to note 25, the environmental information is information specifying at least the sound volume for every section, the position information is a distance, in every section, from an entrance of the specific space to the section, and in the interest level estimation step the level of interest is computed for every section, from a value obtained by multiplying the number of people visiting the section by a weight coefficient, a value obtained by multiplying a ratio of the distance for the section relative to a total value of the distances for all the sections in the specific space by a weight coefficient, and a value obtained by multiplying the sound volume for the section by a weight coefficient.

Note 27

In the interest level estimation method according to note 25, the environmental information is information specifying the sound volume for every section and the temperature for every section, the position information is a distance, in every section, from an entrance of the specific space to the section, the storage device stores a lowest value, for every section, of the number of people visiting the section previously acquired in the information acquisition step, a reference sound volume set in advance for sound volume, and a reference temperature set in advance for temperature, and in the interest level estimation step the level of interest for every section is computed, from a value obtained by multiplying a ratio of the number of people visiting the section relative to the lowest value by a weight coefficient, a value obtained by multiplying a ratio of the distance for the section relative to a total value of the distances for all the sections in the specific space by a weight coefficient, a value obtained by multiplying a ratio of the sound volume for the section relative to the reference sound volume by a weight coefficient, and a value obtained by multiplying a ratio of the temperature for the section relative to the reference temperature by a weight coefficient.

Note 28

In the interest level estimation method according to note 25, the environmental information is information specifying the sound volume for every section and the temperature for every section, the position information is a distance, in every section, from an entrance of the specific space to the section, the storage device stores an average value, for every section, of the numbers of people visiting the section previously acquired in the information acquisition step, an average value, for every section, of sound volumes previously acquired in the information acquisition unit, and an average value, for every section, of temperatures previously acquired in the information acquisition unit, and in the interest level estimation step the level of interest is computed for every section, from a value obtained by multiplying a difference between the number of people visiting the section and the average value of the numbers of people by a weight coefficient, a value obtained by multiplying a ratio of the distance for the section relative to a total value of the distances for all the sections in the specific space by a weight coefficient, a value obtained by multiplying a difference between the sound volume for the section and the average value of sound volumes by a weight coefficient, and a value obtained by multiplying a difference between the temperature for the section and the average value of temperatures by a weight coefficient.

Note 29

In the interest level estimation method according to note 28, the storage device, on the visitor number information and the environmental information being acquired in the information acquisition step, stores the acquired information, and the interest level estimation method further includes an information update step of recalculating the average value of the numbers of people, the average value of sound volumes, and the average value of temperatures stored in the storage unit, using the visitor number information and the environmental information that was stored in the storage device.

Note 30

In the interest level estimation method according to any of notes 22 to 29, the storage device stores, for every section, the level of interest previously estimated in the interest level estimation step, the interest level estimation method further includes a corresponding section specification step of, in a case where interest level estimation in the interest level estimation step cannot be performed in any one of the sections within the specific space, specifying another section corresponding to the section for which the interest level estimation cannot be performed, and a predicting step of predicting the level of interest for the section for which the interest level estimation cannot be performed, based on the previously estimated level of interest for the corresponding other section specified in the corresponding section specification step.

Note 31

In the interest level estimation method according to note 30, in the corresponding section specification step the corresponding other section is specified, using at least one of the level of interest previously estimated for sections other than the section for which the interest level estimation cannot be performed, and the position information, and in the interest level estimation step time windows are set at set intervals back in time based on the current time, with respect to the previously estimated level of interest stored, for the corresponding other section, in the storage device, a time window in which a mode of change is most similar to a latest time window is specified, by contrasting a change in interest level of the latest time window with a change in interest level in time windows other than the latest time window, the past level of interest of the specified time window for the section for which the interest level estimation cannot be performed is extracted from the storage device, and the extracted past level of interest is taken as a current level of interest for the section for which the interest level estimation cannot be performed.

Note 32

The interest level estimation method according to any of notes 22 to 31 further includes a similar space specification step of specifying a similar space that is similar to the specific space, among spaces, other than the specific space, in which a human motion sensor is installed, and a second interest level estimation step of specifying the sections within the specific space and a correspondence relationship between a non-responding section, within the specific space, whose human motion sensor does not respond and a responsive section, within the similar space, whose human motion sensor disposed therein does respond, and predicting the level of interest in the non-responding section, by using the correspondence relationship, the level of interest estimated for every section in the specific space, and a level, estimated for every responsive section within the similar space, to which people visiting the responsive section are interested in the responsive section.

Note 33

In the interest level estimation method according to note 32, in the second interest level estimation step, using the position information of the specific space, information specifying a position of the non-responding section within the specific space, and information specifying a position of each responsive section in the similar space, the responsive sections within the similar space that are respectively similar to the sections within the specific space and the responsive section within the similar space that is similar to the non-responding section are specified as the correspondence relationship.

Note 34

In the interest level estimation method according to note 33, the storage device stores the level previously estimated for every responsive section in the similar space, and in the second interest level estimation step time windows are set at set intervals back in time based on the current time, with respect to the previously estimated level stored, for every responsive section in the similar space, in the storage device, a time window in which a mode of change is most similar to a latest change in interest level estimated for every section within the specific space is specified, by contrasting a change in the level in each time window for every responsive section with the latest change, the level of the specified time window estimated for the responsive section that is similar to the non-responding section is extracted from the storage device, and the extracted level is taken as the level of interest for the non-responding section.

Note 35

A computer-readable recording medium having recorded thereon a program including a command for causing a computer to execute an interest level estimation step of using at least one of environmental information specifying an environment of every section within a specific space and position information specifying a position of every section, and visitor number information specifying, for every section, the number of people visiting the section, to estimate, for every section, a level of interest indicating a level to which people visiting the section are interested in the section.

Note 36

In the computer-readable recording medium according to note 35, the program further includes a command for causing the computer to execute an information acquisition step of acquiring the environmental information from an environmental sensor installed for every section, and acquiring the visitor number information from a human motion sensor installed for every section, the environmental information is information specifying at least one of sound volume for every section and temperature for every section, and in the interest level estimation step, the level of interest is estimated for every section, using the environmental information and the visitor number information acquired in the information acquisition step.

Note 37

In the computer-readable recording medium according to note 36, in the information acquisition step the visitor number information is acquired, by acquiring a response frequency and a response time of the human motion sensor, and applying the acquired response time and response time to a regression equation that is created in advance, and the regression equation is created by regression analysis of a relationship between information obtained from response frequencies and response times of the human motion sensor in a set period and the number of people measured during the set period in a section where the human motion sensor is installed.

Note 38

In the computer-readable recording medium according to note 37, the regression equation includes, as variables, an average value and a variance value of response frequencies of the human motion sensor in a fixed period, and an average value and a variance value of response times of the human motion sensor in the fixed period, and in the information acquisition step the visitor number information is acquired, by computing the average value and the variance value of response frequencies of the human motion sensor in a fixed period and the average value and the variance value of response times of the human motion sensor in the fixed period, from the acquired response frequency and response time, and applying the computed values to the regression equation.

Note 39

In the computer-readable recording medium according to note 35, the program further includes a command for causing the computer to execute an information acquisition step of acquiring the visitor number information from a human motion sensor installed for every section, and the position information is stored in advance in a storage device, and in the interest level estimation step the level of interest for every section is estimated, using the position information stored in the storage device and the visitor number information acquired in the information acquisition step.

Note 40

In the computer-readable recording medium according to note 39, in the information acquisition step the visitor number information is acquired, by acquiring a response frequency and a response time of the human motion sensor, and applying the acquired response time and response time to a regression equation that is created in advance, and the regression equation is created by regression analysis of a relationship between information obtained from response frequencies and response times of the human motion sensor in a set period and the number of people measured during the set period in a section where the human motion sensor is installed.

Note 41

In the computer-readable recording medium according to note 40, the regression equation includes, as variables, an average value and a variance value of response frequencies of the human motion sensor in a fixed period, and an average value and a variance value of response times of the human motion sensor in the fixed period, and in the information acquisition step the visitor number information is acquired, by computing the average value and the variance value of response frequencies of the human motion sensor in a fixed period and the average value and the variance value of response times of the human motion sensor in the fixed period, from the acquired response frequency and response time, and applying the computed values to the regression equation.

Note 42

In the computer-readable recording medium according to any of notes 39 to 41, in the information acquisition step the environmental information is further acquired from an environmental sensor installed for every section, the environmental information is information specifying at least one of sound volume for every section and temperature for every section, and in the interest level estimation step the level of interest is estimated for every section, further using the environmental information acquired in the information acquisition step.

Note 43

In the computer-readable recording medium according to note 42, the environmental information is information specifying at least the sound volume for every section, the position information is a distance, in every section, from an entrance of the specific space to the section, and in the interest level estimation step the level of interest is computed for every section, from a value obtained by multiplying the number of people visiting the section by a weight coefficient, a value obtained by multiplying a ratio of the distance for the section relative to a total value of the distances for all the sections in the specific space by a weight coefficient, and a value obtained by multiplying the sound volume for the section by a weight coefficient.

Note 44

In the computer-readable recording medium according to note 42, the environmental information is information specifying the sound volume for every section and the temperature for every section, the position information is a distance, in every section, from an entrance of the specific space to the section, the storage device stores a lowest value, for every section, of the number of people visiting the section previously acquired in the information acquisition step, a reference sound volume set in advance for sound volume, and a reference temperature set in advance for temperature, and in the interest level estimation step the level of interest for every section is computed, from a value obtained by multiplying a ratio of the number of people visiting the section relative to the lowest value by a weight coefficient, a value obtained by multiplying a ratio of the distance for the section relative to a total value of the distances for all the sections in the specific space by a weight coefficient, a value obtained by multiplying a ratio of the sound volume for the section relative to the reference sound volume by a weight coefficient, and a value obtained by multiplying a ratio of the temperature for the section relative to the reference temperature by a weight coefficient.

Note 45

In the computer-readable recording medium according to note 42, the environmental information is information specifying the sound volume for every section and the temperature for every section, the position information is a distance, in every section, from an entrance of the specific space to the section, the storage device stores an average value, for every section, of the numbers of people visiting the section previously acquired in the information acquisition step, an average value, for every section, of sound volumes previously acquired in the information acquisition unit, and an average value, for every section, of temperatures previously acquired in the information acquisition unit, and in the interest level estimation step the level of interest is computed for every section, from a value obtained by multiplying a difference between the number of people visiting the section and the average value of the numbers of people by a weight coefficient, a value obtained by multiplying a ratio of the distance for the section relative to a total value of the distances for all the sections in the specific space by a weight coefficient, a value obtained by multiplying a difference between the sound volume for the section and the average value of sound volumes by a weight coefficient, and a value obtained by multiplying a difference between the temperature for the section and the average value of temperatures by a weight coefficient.

Note 46

In the computer-readable recording medium according to note 45, the storage device, on the visitor number information and the environmental information being acquired in the information acquisition step, stores the acquired information, and the program further includes a command for causing the computer to execute an information update step of recalculating the average value of the numbers of people, the average value of sound volumes, and the average value of temperatures stored in the storage unit, using the visitor number information and the environmental information that was stored in the storage device.

Note 47

In the computer-readable recording medium according to any of notes 39 to 46, the storage device stores, for every section, the level of interest previously estimated in the interest level estimation step, the program further includes a command for causing the computer to execute a corresponding section specification step of, in a case where interest level estimation in the interest level estimation step cannot be performed in any one of the sections within the specific space, specifying another section corresponding to the section for which the interest level estimation cannot be performed, and a predicting step of predicting the level of interest for the section for which the interest level estimation cannot be performed, based on the previously estimated level of interest for the corresponding other section specified in the corresponding section specification step.

Note 48

In the computer-readable recording medium according to note 47, in the corresponding section specification step the corresponding other section is specified, using at least one of the level of interest previously estimated for sections other than the section for which the interest level estimation cannot be performed, and the position information, and in the interest level estimation step time windows are set at set intervals back in time based on the current time, with respect to the previously estimated level of interest stored, for the corresponding other section, in the storage device, a time window in which a mode of change is most similar to a latest time window is specified, by contrasting a change in interest level of the latest time window with a change in interest level in time windows other than the latest time window, the past level of interest of the specified time window for the section for which the interest level estimation cannot be performed is extracted from the storage device, and the extracted past level of interest is taken as a current level of interest for the section for which the interest level estimation cannot be performed.

Note 49

In the computer-readable recording medium according to any of notes 39 to 48, the program further includes a command for causing the computer to execute a similar space specification step of specifying a similar space that is similar to the specific space, among spaces, other than the specific space, in which a human motion sensor is installed, and a second interest level estimation step of specifying the sections within the specific space and a correspondence relationship between a non-responding section, within the specific space, whose human motion sensor does not respond and a responsive section, within the similar space, whose human motion sensor disposed therein does respond, and predicting the level of interest in the non-responding section, by using the correspondence relationship, the level of interest estimated for every section in the specific space, and a level, estimated for every responsive section within the similar space, to which people visiting the responsive section are interested in the responsive section.

Note 50

In the computer-readable recording medium according to note 49, in the second interest level estimation step, using the position information of the specific space, information specifying a position of the non-responding section within the specific space, and information specifying a position of each responsive section in the similar space, the responsive sections within the similar space that are respectively similar to the sections within the specific space and the responsive section within the similar space that is similar to the non-responding section are specified as the correspondence relationship.

Note 51

In the computer-readable recording medium according to note 50, the storage device stores the level previously estimated for every responsive section in the similar space, and in the second interest level estimation step time windows are set at set intervals back in time based on the current time, with respect to the previously estimated level stored, for every responsive section in the similar space, in the storage device, a time window in which a mode of change is most similar to a latest change in interest level estimated for every section within the specific space is specified, by contrasting a change in the level in each time window for every responsive section with the latest change, the level of the specified time window estimated for the responsive section that is similar to the non-responding section is extracted from the storage device, and the extracted level is taken as the level of interest for the non-responding section.

Although the invention of this application was described heretofore with reference to the embodiments, the invention of this application is not limited to the above embodiments. Those skilled in the art will appreciate that various modifications can be made to the configurations and details of the invention of this application without departing from the scope of the invention of this application.

This application is based upon and claims the benefit of priority of the prior Japanese Patent Application No. 2010-143585, filed on Jun. 24, 2010, and the prior Japanese Patent Application No. 2010-187374, filed on Aug. 24, 2010, the entire contents of which are incorporated herein by reference.

### INDUSTRIAL APPLICABILITY

As mentioned above, the present invention enables an index capable of representing the actual situation in a specific space to be provided. Accordingly, the present invention is useful in various types of analytical fields such as sales analysis and advertising analysis

### DESCRIPTION OF REFERENCE NUMERALS

10 Interest level estimation apparatus (Embodiment 1)
11 Interest level estimation unit
12 Information acquisition unit
13 Storage unit
14 Output unit
15 Information update unit
16 Corresponding section specification unit
17 Similar space specification unit
20 Interest level estimation apparatus (Embodiment 2)
30 Interest level estimation apparatus (Embodiment 3)
40 Interest level estimation apparatus (Embodiment 4)
100, 100-1 to 100-4 Specific space
101 Sensor post
102 Reference point
103 Line of flow
110 Computer
111 CPU
112 Main memory
113 Storage device
114 Input interface
115 Display controller
116 Data reader/writer
117 Communication interface
118 Input device
119 Display device
120 Recording medium
121 Bus
200 Digital signage apparatus
201 Video data generation unit
202 Display device
203 Storage unit

1-19. (canceled)

20. An interest level estimation apparatus comprising an interest level estimation unit that, using at least one of environmental information specifying an environment of every section within a specific space and position information specifying a position of every section, and visitor number information specifying, for every section, the number of people visiting the section, estimates, for every section, a level of interest indicating a level to which people visiting the section are interested in the section.

21. The interest level estimation apparatus according to claim 20, further comprising an information acquisition unit that acquires the environmental information from an environmental sensor installed for every section, and acquires the visitor number information from a human motion sensor installed for every section,
wherein the environmental information is information specifying at least one of sound volume for every section and temperature for every section, and
the interest level estimation unit estimates the level of interest for every section, using the environmental information and the visitor number information acquired by the information acquisition unit.

22. The interest level estimation apparatus according to claim 21,
wherein the information acquisition unit acquires the visitor number information, by acquiring a response frequency and a response time of the human motion sensor, and applying the acquired response frequency and response time to a regression equation that is created in advance, and
the regression equation is created by regression analysis of a relationship between information obtained from response frequencies and response times of the human motion sensor in a set period and the number of people measured during the set period in a section where the human motion sensor is installed.

23. The interest level estimation apparatus according to claim 22,
wherein the regression equation includes, as variables, an average value and a variance value of response frequencies of the human motion sensor in a fixed period, and an average value and a variance value of response times of the human motion sensor in the fixed period, and
the information acquisition unit acquires the visitor number information, by computing the average value and the variance value of response frequencies of the human motion sensor in a fixed period and the average value and the variance value of response times of the human motion sensor in the fixed period, from the acquired response frequency and response time, and applying the computed values to the regression equation.

24. The interest level estimation apparatus according to claim 20, further comprising:
an information acquisition unit that acquires the visitor number information from a human motion sensor installed for every section; and
a storage unit that stores the position information,
wherein the interest level estimation unit estimates the level of interest for every section, using the position information stored in the storage unit and the visitor number information acquired by the information acquisition unit.

25. The interest level estimation apparatus according to claim 24,
wherein the information acquisition unit acquires the visitor number information, by acquiring a response frequency and a response time of the human motion sensor, and applying the acquired response frequency and response time to a regression equation that is created in advance, and
the regression equation is created by regression analysis of a relationship between information obtained from response frequencies and response times of the human motion sensor in a set period and the number of people measured during the set period in a section where the human motion sensor is installed.

26. The interest level estimation apparatus according to claim 25,
wherein the regression equation includes, as variables, an average value and a variance value of response frequencies of the human motion sensor in a fixed period, and an average value and a variance value of response times of the human motion sensor in the fixed period, and
the information acquisition unit acquires the visitor number information, by computing the average value and the variance value of response frequencies of the human motion sensor in a fixed period and the average value and the variance value of response times of the human motion sensor in the fixed period, from the acquired response frequency and response time, and applying the computed values to the regression equation.

27. The interest level estimation apparatus according to claim 24,
wherein the information acquisition unit further acquires the environmental information from an environmental sensor installed for every section,
the environmental information is information specifying at least one of sound volume for every section and temperature for every section, and
the interest level estimation unit estimates the level of interest for every section, further using the environmental information acquired by the information acquisition unit.

28. The interest level estimation apparatus according to claim 27,
wherein the environmental information is information specifying at least the sound volume for every section,
the position information is a distance, in every section, from an entrance of the specific space to the section, and
the interest level estimation unit computes the level of interest for every section, from a value obtained by multiplying the number of people visiting the section by a weight coefficient, a value obtained by multiplying a ratio of the distance for the section relative to a total value of the distances for all the sections in the specific space by a weight coefficient, and a value obtained by multiplying the sound volume for the section by a weight coefficient.

29. The interest level estimation apparatus according to claim 27,
wherein the environmental information is information specifying the sound volume for every section and the temperature for every section,
the position information is a distance, in every section, from an entrance of the specific space to the section,
the storage unit further stores a lowest value, for every section, of the number of people visiting the section previously acquired by the information acquisition unit, a reference sound volume set in advance for sound volume, and a reference temperature set in advance for temperature, and
the interest level estimation unit computes the level of interest for every section, from a value obtained by multiplying a ratio of the number of people visiting the section relative to the lowest value by a weight coefficient, a value obtained by multiplying a ratio of the distance for the section relative to a total value of the distances for all the sections in the specific space by a weight coefficient, a value obtained by multiplying a ratio of the sound volume for the section relative to the reference sound volume by a weight coefficient, and a value obtained by multiplying a ratio of the temperature for the section relative to the reference temperature by a weight coefficient.

30. The interest level estimation apparatus according to claim 27,
wherein the environmental information is information specifying the sound volume for every section and the temperature for every section,
the position information is a distance, in every section, from an entrance of the specific space to the section,
the storage unit further stores an average value, for every section, of the numbers of people visiting the section previously acquired by the information acquisition unit, an average value, for every section, of sound volumes previously acquired by the information acquisition unit, and an average value, for every section, of temperatures previously acquired by the information acquisition unit, and
the interest level estimation unit computes the level of interest for every section, from a value obtained by multiplying a difference between the number of people visiting the section and the average value of the numbers of people by a weight coefficient, a value obtained by multiplying a ratio of the distance for the section relative to a total value of the distances for all the sections in the specific space by a weight coefficient, a value obtained by multiplying a difference between the sound volume for the section and the average value of sound volumes by a weight coefficient, and a value obtained by multiplying a difference between the temperature for the section and the average value of temperatures by a weight coefficient.

31. The interest level estimation apparatus according to claim 30,
wherein the information acquisition unit, on acquiring the visitor number information and the environmental information, stores the acquired information in the storage unit, and
the interest level estimation apparatus further comprises an information update unit that recalculates the average value of the numbers of people, the average value of sound volumes, and the average value of temperatures stored in the storage unit, using the visitor number information and the environmental information that was stored in the storage unit.

32. The interest level estimation apparatus according to claim 24, further comprising a corresponding section specification unit that, in a case where interest level estimation by the interest level estimation unit cannot be performed in any one of the sections within the specific space, specifies another section corresponding to the section for which the interest level estimation cannot be performed,
the storage unit stores, for every section, the level of interest previously estimated by the interest level estimation unit, and
the interest level estimation unit predicts the level of interest for the section for which the interest level estimation cannot be performed, based on the previously estimated level of interest for the corresponding other section specified by the corresponding section specification unit.

33. The interest level estimation apparatus according to claim 32,
wherein the corresponding section specification unit specifies the corresponding other section, using at least one of the level of interest previously estimated for sections other than the section for which the interest level estimation cannot be performed, and the position information, and
the interest level estimation unit sets time windows at set intervals back in time based on the current time, with respect to the previously estimated level of interest stored, for the corresponding other section, in the storage unit, specifies a time window in which a mode of change is most similar to a latest time window, by contrasting a change in interest level of the latest time window with a change in interest level in time windows other than the latest time window, extracts the past level of interest of the specified time window for the section for which the interest level estimation cannot be performed from the storage unit, and takes the extracted past level of interest as a current level of interest for the section for which the interest level estimation cannot be performed.

34. The interest level estimation apparatus according to claim 24, further comprising a similar space specification unit that specifies a similar space that is similar to the specific space, among spaces, other than the specific space, in which a human motion sensor is installed,
wherein the interest level estimation unit specifies the sections within the specific space and a correspondence relationship between a non-responding section, within the specific space, whose human motion sensor does not respond and a responsive section, within the similar space, whose human motion sensor disposed therein does respond, and predicts the level of interest in the non-responding section, using the correspondence relationship, the level of interest estimated for every section in the specific space, and a level, estimated for every responsive section within the similar space, to which people visiting the responsive section are interested in the responsive section.

35. The interest level estimation apparatus according to claim 34,
wherein the interest level estimation unit, using the position information of the specific space, information specifying a position of the non-responding section within the specific space, and information specifying a position of each responsive section in the similar space, specifies, as the correspondence relationship, the responsive sections within the similar space that are respectively similar to the sections within the specific space and the responsive section within the similar space that is similar to the non-responding section.

36. The interest level estimation apparatus according to claim 35,
wherein the storage unit stores the level previously estimated for every responsive section in the similar space, and
the interest level estimation unit sets time windows at set intervals back in time based on the current time, with respect to the previously estimated level stored, for every responsive section in the similar space, in the storage unit, specifies a time window in which a mode of change is most similar to a latest change in interest level estimated for every section within the specific space, by contrasting a change in the level in each time window for every responsive section with the latest change, extracts the level of the specified time window estimated for the responsive section that is similar to the non-responding section from the storage unit, and takes the extracted level as the level of interest for the non-responding section.

37. An interest level estimation method comprising an interest level estimation step of using at least one of environmental information specifying an environment of every section within a specific space and position information specifying a position of every section, and visitor number information specifying, for every section, the number of people visiting the section, to estimate, for every section, a level of interest indicating a level to which people visiting the section are interested in the section.

38. The interest level estimation method according to claim 37 further comprising an information acquisition step of acquiring the environmental information from an environmental sensor installed for every section, and acquiring the visitor number information from a human motion sensor installed for every section, the environmental information is information specifying at least one of sound volume for every section and temperature for every section, and in the interest level estimation step, the level of interest is estimated for every section, using the environmental information and the visitor number information acquired in the information acquisition step.

39. In the interest level estimation method according to claim 38, in the information acquisition step the visitor number information is acquired, by acquiring a response frequency and a response time of the human motion sensor, and applying the acquired response frequency and response time to a regression equation that is created in advance, and the regression equation is created by regression analysis of a relationship between information obtained from response frequencies and response times of the human motion sensor in a set period and the number of people measured during the set period in a section where the human motion sensor is installed.

40. In the interest level estimation method according to claim 39, the regression equation includes, as variables, an average value and a variance value of response frequencies of the human motion sensor in a fixed period, and an average value and a variance value of response times of the human motion sensor in the fixed period, and in the information acquisition step the visitor number information is acquired, by computing the average value and the variance value of response frequencies of the human motion sensor in a fixed period and the average value and the variance value of response times of the human motion sensor in the fixed period, from the acquired response frequency and response time, and applying the computed values to the regression equation.

41. The interest level estimation method according to claim 37 further comprising an information acquisition step of acquiring the visitor number information from a human motion sensor installed for every section, and the position information is stored in advance in a storage device, and in the interest level estimation step the level of interest for every section is estimated, using the position information stored in the storage device and the visitor number information acquired in the information acquisition step.

42. In the interest level estimation method according to claim 41, in the information acquisition step the visitor number information is acquired, by acquiring a response frequency and a response time of the human motion sensor, and applying the acquired response frequency and response time to a regression equation that is created in advance, and the regression equation is created by regression analysis of a relationship between information obtained from response frequencies and response times of the human motion sensor in a set period and the number of people measured during the set period in a section where the human motion sensor is installed.

43. In the interest level estimation method according to claim 42, the regression equation includes, as variables, an average value and a variance value of response frequencies of the human motion sensor in a fixed period, and an average value and a variance value of response times of the human motion sensor in the fixed period, and in the information acquisition step the visitor number information is acquired, by computing the average value and the variance value of response frequencies of the human motion sensor in a fixed period and the average value and the variance value of response times of the human motion sensor in the fixed period, from the acquired response frequency and response time, and applying the computed values to the regression equation.

44. In the interest level estimation method according to claim 41, in the information acquisition step the environmental information is further acquired from an environmental sensor installed for every section, the environmental information is information specifying at least one of sound volume for every section and temperature for every section, and in the interest level estimation step the level of interest is estimated for every section, further using the environmental information acquired in the information acquisition step.

45. In the interest level estimation method according to claim 44, the environmental information is information specifying at least the sound volume for every section, the position information is a distance, in every section, from an entrance of the specific space to the section, and in the interest level estimation step the level of interest is computed for every section, from a value obtained by multiplying the number of people visiting the section by a weight coefficient, a value obtained by multiplying a ratio of the distance for the section relative to a total value of the distances for all the sections in the specific space by a weight coefficient, and a value obtained by multiplying the sound volume for the section by a weight coefficient.

46. In the interest level estimation method according to claim 44, the environmental information is information specifying the sound volume for every section and the temperature for every section, the position information is a distance, in every section, from an entrance of the specific space to the section, the storage device stores a lowest value, for every section, of the number of people visiting the section previously acquired in the information acquisition step, a reference sound volume set in advance for sound volume, and a reference temperature set in advance for temperature, and in the interest level estimation step the level of interest for every section is computed, from a value obtained by multiplying a ratio of the number of people visiting the section relative to the lowest value by a weight coefficient, a value obtained by multiplying a ratio of the distance for the section relative to a total value of the distances for all the sections in the specific space by a weight coefficient, a value obtained by multiplying a ratio of the sound volume for the section relative to the reference sound volume by a weight coefficient, and a value obtained by multiplying a ratio of the temperature for the section relative to the reference temperature by a weight coefficient.

47. In the interest level estimation method according to claim 44, the environmental information is information specifying the sound volume for every section and the temperature for every section, the position information is a distance, in every section, from an entrance of the specific space to the section, the storage device stores an average value, for every section, of the numbers of people visiting the section previously acquired in the information acquisition step, an average value, for every section, of sound volumes previously acquired in the information acquisition step, and an average value, for every section, of temperatures previously acquired in the information acquisition step, and in the interest level estimation step the level of interest is computed for every section, from a value obtained by multiplying a difference between the number of people visiting the section and the average value of the numbers of people by a weight coefficient, a value obtained by multiplying a ratio of the distance for the section relative to a total value of the distances for all the sections in the specific space by a weight coefficient, a value obtained by multiplying a difference between the sound volume for the section and the average value of sound volumes by a weight coefficient, and a value obtained by multiplying a difference between the temperature for the section and the average value of temperatures by a weight coefficient.

48. In the interest level estimation method according to claim 47, the storage device, on the visitor number information and the environmental information being acquired in the information acquisition step, stores the acquired information, and the interest level estimation method further comprising an information update step of recalculating the average value of the numbers of people, the average value of sound volumes, and the average value of temperatures stored in the storage device, using the visitor number information and the environmental information that was stored in the storage device.

49. In the interest level estimation method according to claim 41, the storage device stores, for every section, the level of interest previously estimated in the interest level estimation step, the interest level estimation method further comprising a corresponding section specification step of, in a case where interest level estimation in the interest level estimation step cannot be performed in any one of the sections within the specific space, specifying another section corresponding to the section for which the interest level estimation cannot be performed, and a predicting step of predicting the level of interest for the section for which the interest level estimation cannot be performed, based on the previously estimated level of interest for the corresponding other section specified in the corresponding section specification step.

50. In the interest level estimation method according to claim 49, in the corresponding section specification step the corresponding other section is specified, using at least one of the level of interest previously estimated for sections other than the section for which the interest level estimation cannot be performed, and the position information, and in the interest level estimation step time windows are set at set intervals back in time based on the current time, with respect to the previously estimated level of interest stored, for the corresponding other section, in the storage device, a time window in which a mode of change is most similar to a latest time window is specified, by contrasting a change in interest level of the latest time window with a change in interest level in time windows other than the latest time window, the past level of interest of the specified time window for the section for which the interest level estimation cannot be performed is extracted from the storage device, and the extracted past level of interest is taken as a current level of interest for the section for which the interest level estimation cannot be performed.

51. The interest level estimation method according to claim 41 further comprising a similar space specification step of specifying a similar space that is similar to the specific space, among spaces, other than the specific space, in which a human motion sensor is installed, and a second interest level estimation step of specifying the sections within the specific space and a correspondence relationship between a non-responding section, within the specific space, whose human motion sensor does not respond and a responsive section, within the similar space, whose human motion sensor disposed therein does respond, and predicting the level of interest in the non-responding section, by using the correspondence relationship, the level of interest estimated for every section in the specific space, and a level, estimated for every responsive section within the similar space, to which people visiting the responsive section are interested in the responsive section.

52. In the interest level estimation method according to claim 51, in the second interest level estimation step, using the position information of the specific space, information specifying a position of the non-responding section within the specific space, and information specifying a position of each responsive section in the similar space, the responsive sections within the similar space that are respectively similar to the sections within the specific space and the responsive section within the similar space that is similar to the non-responding section are specified as the correspondence relationship.

53. In the interest level estimation method according to claim 52, the storage device stores the level previously estimated for every responsive section in the similar space, and in the second interest level estimation step time windows are set at set intervals back in time based on the current time, with respect to the previously estimated level stored, for every responsive section in the similar space, in the storage device, a time window in which a mode of change is most similar to a latest change in interest level estimated for every section within the specific space is specified, by contrasting a change in the level in each time window for every responsive section with the latest change, the level of the specified time window estimated for the responsive section that is similar to the non-responding section is extracted from the storage device, and the extracted level is taken as the level of interest for the non-responding section.

54. A computer-readable recording medium having recorded thereon a program including a command for causing a computer to execute an interest level estimation step of using at least one of environmental information specifying an environment of every section within a specific space and position information specifying a position of every section, and visitor number information specifying, for every section, the number of people visiting the section, to estimate, for every section, a level of interest indicating a level to which people visiting the section are interested in the section.

55. In the computer-readable recording medium according to claim 54, the program further comprising a command for causing the computer to execute an information acquisition step of acquiring the environmental information from an environmental sensor installed for every section, and acquiring the visitor number information from a human motion sensor installed for every section, the environmental information is information specifying at least one of sound volume for every section and temperature for every section, and in the interest level estimation step, the level of interest is estimated for every section, using the environmental information and the visitor number information acquired in the information acquisition step.

56. In the computer-readable recording medium according to claim 55, in the information acquisition step the visitor number information is acquired, by acquiring a response frequency and a response time of the human motion sensor, and applying the acquired response frequency and response time to a regression equation that is created in advance, and the regression equation is created by regression analysis of a relationship between information obtained from response frequencies and response times of the human motion sensor in a set period and the number of people measured during the set period in a section where the human motion sensor is installed.

57. In the computer-readable recording medium according to claim 56, the regression equation includes, as variables, an average value and a variance value of response frequencies of the human motion sensor in a fixed period, and an average value and a variance value of response times of the human motion sensor in the fixed period, and in the information acquisition step the visitor number information is acquired, by computing the average value and the variance value of response frequencies of the human motion sensor in a fixed period and the average value and the variance value of response times of the human motion sensor in the fixed period, from the acquired response frequency and response time, and applying the computed values to the regression equation.

58. In the computer-readable recording medium according to claim 54, the program further comprising a command for causing the computer to execute an information acquisition step of acquiring the visitor number information from a human motion sensor installed for every section, and the position information is stored in advance in a storage device, and in the interest level estimation step the level of interest for every section is estimated, using the position information stored in the storage device and the visitor number information acquired in the information acquisition step.

59. In the computer-readable recording medium according to claim 58, in the information acquisition step the visitor number information is acquired, by acquiring a response frequency and a response time of the human motion sensor, and applying the acquired response frequency and response time to a regression equation that is created in advance, and the regression equation is created by regression analysis of a relationship between information obtained from response frequencies and response times of the human motion sensor in a set period and the number of people measured during the set period in a section where the human motion sensor is installed.

60. In the computer-readable recording medium according to claim 59, the regression equation includes, as variables, an average value and a variance value of response frequencies of the human motion sensor in a fixed period, and an average value and a variance value of response times of the human motion sensor in the fixed period, and in the information acquisition step the visitor number information is acquired, by computing the average value and the variance value of response frequencies of the human motion sensor in a fixed period and the average value and the variance value of response times of the human motion sensor in the fixed period, from the acquired response frequency and response time, and applying the computed values to the regression equation.

61. In the computer-readable recording medium according to claim 58, in the information acquisition step the environmental information is further acquired from an environmental sensor installed for every section, the environmental information is information specifying at least one of sound volume for every section and temperature for every section, and in the interest level estimation step the level of interest is estimated for every section, further using the environmental information acquired in the information acquisition step.

62. In the computer-readable recording medium according to claim 61, the environmental information is information specifying at least the sound volume for every section, the position information is a distance, in every section, from an entrance of the specific space to the section, and in the interest level estimation step the level of interest is computed for every section, from a value obtained by multiplying the number of people visiting the section by a weight coefficient, a value obtained by multiplying a ratio of the distance for the section relative to a total value of the distances for all the sections in the specific space by a weight coefficient, and a value obtained by multiplying the sound volume for the section by a weight coefficient.

63. In the computer-readable recording medium according to claim 61, the environmental information is information specifying the sound volume for every section and the temperature for every section, the position information is a distance, in every section, from an entrance of the specific space to the section, the storage device stores a lowest value, for every section, of the number of people visiting the section previously acquired in the information acquisition step, a reference sound volume set in advance for sound volume, and a reference temperature set in advance for temperature, and in the interest level estimation step the level of interest for every section is computed, from a value obtained by multiplying a ratio of the number of people visiting the section relative to the lowest value by a weight coefficient, a value obtained by multiplying a ratio of the distance for the section relative to a total value of the distances for all the sections in the specific space by a weight coefficient, a value obtained by multiplying a ratio of the sound volume for the section relative to the reference sound volume by a weight coefficient, and a value obtained by multiplying a ratio of the temperature for the section relative to the reference temperature by a weight coefficient.

64. In the computer-readable recording medium according to claim 61, the environmental information is information specifying the sound volume for every section and the temperature for every section, the position information is a distance, in every section, from an entrance of the specific space to the section, the storage device stores an average value, for every section, of the numbers of people visiting the section previously acquired in the information acquisition step, an average value, for every section, of sound volumes previously acquired in the information acquisition step, and an average value, for every section, of temperatures previously acquired in the information acquisition step, and in the interest level estimation step the level of interest is computed for every section, from a value obtained by multiplying a difference between the number of people visiting the section and the average value of the numbers of people by a weight coefficient, a value obtained by multiplying a ratio of the distance for the section relative to a total value of the distances for all the sections in the specific space by a weight coefficient, a value obtained by multiplying a difference between the sound volume for the section and the average value of sound volumes by a weight coefficient, and a value obtained by multiplying a difference between the temperature for the section and the average value of temperatures by a weight coefficient.

65. In the computer-readable recording medium according to claim 64, the storage device, on the visitor number information and the environmental information being acquired in the information acquisition step, stores the acquired information, and, the program further comprising a command for causing the computer to execute an information update step of recalculating the average value of the numbers of people, the average value of sound volumes, and the average value of temperatures stored in the storage device, using the visitor number information and the environmental information that was stored in the storage device.

66. In the computer-readable recording medium according to claim 58, the storage device stores, for every section, the level of interest previously estimated in the interest level estimation step, the program further comprising a command for causing the computer to execute a corresponding section specification step of, in a case where interest level estimation in the interest level estimation step cannot be performed in any one of the sections within the specific space, specifying another section corresponding to the section for which the interest level estimation cannot be performed, and a predicting step of predicting the level of interest for the section for which the interest level estimation cannot be performed, based on the previously estimated level of interest for the corresponding other section specified in the corresponding section specification step.

67. In the computer-readable recording medium according to claim 66, in the corresponding section specification step the corresponding other section is specified, using at least one of the level of interest previously estimated for sections other than the section for which the interest level estimation cannot be performed, and the position information, and in the interest level estimation step time windows are set at set intervals back in time based on the current time, with respect to the previously estimated level of interest stored, for the corresponding other section, in the storage device, a time window in which a mode of change is most similar to a latest time window is specified, by contrasting a change in interest level of the latest time window with a change in interest level in time windows other than the latest time window, the past level of interest of the specified time window for the section for which the interest level estimation cannot be performed is extracted from the storage device, and the extracted past level of interest is taken as a current level of interest for the section for which the interest level estimation cannot be performed.

68. In the computer-readable recording medium according to claim 58, the program further comprising a command for causing the computer to execute a similar space specification step of specifying a similar space that is similar to the specific space, among spaces, other than the specific space, in which a human motion sensor is installed, and a second interest level estimation step of specifying the sections within the specific space and a correspondence relationship between a non-responding section, within the specific space, whose human motion sensor does not respond and a responsive section, within the similar space, whose human motion sensor disposed therein does respond, and predicting the level of interest in the non-responding section, by using the correspondence relationship, the level of interest estimated for every section in the specific space, and a level, estimated for every responsive section within the similar space, to which people visiting the responsive section are interested in the responsive section.

69. In the computer-readable recording medium according to claim 68, in the second interest level estimation step, using the position information of the specific space, information specifying a position of the non-responding section within the specific space, and information specifying a position of each responsive section in the similar space, the responsive sections within the similar space that are respectively similar to the sections within the specific space and the responsive section within the similar space that is similar to the non-responding section are specified as the correspondence relationship.

70. In the computer-readable recording medium according to claim 69, the storage device stores the level previously estimated for every responsive section in the similar space, and in the second interest level estimation step time windows are set at set intervals back in time based on the current time, with respect to the previously estimated level stored, for every responsive section in the similar space, in the storage device, a time window in which a mode of change is most similar to a latest change in interest level estimated for every section within the specific space is specified, by contrasting a change in the level in each time window for every responsive section with the latest change, the level of the specified time window estimated for the responsive section that is similar to the non-responding section is extracted from the storage device, and the extracted level is taken as the level of interest for the non-responding section.
